(19) United States
(12) Patent Application Publication
(10) Pub. No.: US 2026/0184624 A1
(43) Pub. Date: Jul. 2, 2026

(54) DECORATIVE ENAMEL FOR AUTOMOTIVE GLASSES AND ASSOCIATED METHODS

(71) Applicant: CORNING INCORPORATED, CORNING, NY (US)

(72) Inventors: Mickaël Berrebi, Paris (FR); Lionel Joel Mary Beunet, Sorques (FR); Jean-Francois Georges Bruneaux, Bagneaux Sur Loing (FR); Marie Jacqueline Monique Comte, Plougasnou (FR); Odile Fraboulet, Avon (FR); Philippe Lehuede, Dammarie-les-Lys (FR); Soumyadyuti Samai, Paris (FR)

(21) Appl. No.: 18/863,884

(22) PCT Filed: May 2, 2023
(86) PCT No.: PCT/US2023/020641

§ 371 Date: Nov. 7, 2024

Related U.S. Application Data
(60) Provisional application No. 63/343,226, filed on May 18, 2022.
(60) Provisional application No. 63/428,536, filed on Nov. 29, 2022.

(51) Int. Cl. C03C 17/42; C03C 1/04; C03C 4/02; C03C 11/00; C03C 17/04

(52) U.S. Cl. CPC C03C 17/42; C03C 1/04; C03C 4/02; C03C 11/007; C03C 17/04; C03C 2217/425; C03C 2217/475; C03C 2217/485

(57) ABSTRACT

A decorated glass article comprises a glass substrate, a first major surface, and a second major surface disposed opposite to the first major surface. The decorated glass article comprises a decorative layer adhered to at least a portion of the second major surface. The decorative layer comprises a glass flux matrix and a plurality of pores such that the decorative layer exhibits a porosity of at least 5%. The porosity of the decorative layers beneficially prevents the decorative layers from degrading mechanical strength of the glass substrate while also providing optical performance attributes suitable for various decorative application, such as use in an obscuration in automotive glazings.

### CROSS-REFERENCE TO RELATED APPLICATIONS

This application claims the benefit of priority under 35 U.S.C. § 119 of U.S. Provisional Application Ser. No. 63/343,226 filed on May 18, 2022 and U.S. Provisional Application Ser. No. 63/428,536 filed on Nov. 29, 2022 the contents of which are relied upon and incorporated herein by reference in their entirety.

### TECHNICAL FIELD

This application relates to decorative enamels for automotive glasses, and more particularly, to porous decorative enamels.

### BACKGROUND

Enamel layers are commonly used as decorative and tinting elements for automotive glass such as windshields, sunroofs and rear windows. As decorations, enamel typically takes the form of dot gradients and borders along the periphery of window glass. Decorative layers can serve both to enhance appearance and to protect underlying adhesives from ultraviolet degradation, for example.

Automotive glass has conventionally been formed from thermally tempered soda-lime silica glass. Thermal tempering induces surface compressive stress that strengthens the glass against mechanical failure. However, the stresses and inherent risks of the road require conventional automotive glass to be relatively thick and heavy for a desired level of durability. Because such soda-lime silica glasses tend to suffer from several drawbacks from a durability standpoint. Examples of such drawbacks of soda-lime silicates include poor chemical weathering performance, impact performance, and scratch performance.

Borosilicate glasses are being considered for automotive window applications because they have several advantages over soda-lime silica glass, including improved chemical weathering performance, improved scratch resistance, improved impact performance, and favorable low densities. One complexity associated with borosilicate glasses is that such glasses tend to have coefficients of thermal expansion (“CTEs”) that are lower than those associated with soda-lime silica glasses or aluminosilicate glasses. Such lower coefficients of thermal expansion associated with borosilicate glasses may be incompatible with commercially available ceramic enamels. CTE differences between borosilicate glasses and commercially available enamels may degrade mechanical performance of the windshield glass and prevent the windshield glass from having a desired appearance.

Accordingly, there is a need for an improved enamel for use in combination with borosilicate glasses or other suitable low-CTE material.

### SUMMARY

The disclosure provides, among other things, decorative enamels that are suitable for use with borosilicate glasses. The decorative enamels described herein beneficially provide relatively low coefficients of thermal expansion that are comparable (e.g., within 10×10⁻⁷K⁻¹) of an associated borosilicate glass. The decorative enamels described herein further exhibit favorable mechanical performance attributes when deposited on borosilicate glasses, as decorated glass articles may exhibit mechanical strength characteristics that are comparable to or even better than those associated with undecorated glass articles. The decorative enamels described herein may not degrade the strength of the glass.

An aspect (1) of the present disclosure pertains to a decorated glass article comprising: a glass substrate comprising a coefficient of thermal expansion (“CTE”) that is less than or equal to 55×10⁻⁷ K⁻¹, a first major surface, and a second major surface disposed opposite to the first major surface; and a decorative layer adhered to at least a portion of the second major surface, the decorative layer comprising: a glass flux matrix, a plurality of low CTE additive component particles, and a plurality of pores, wherein: the decorative layer comprises greater than 15 wt % of the low CTE additive component particles, each of the plurality of low CTE additive component particles comprises a CTE that is less than or equal to 10×10⁻⁷ K⁻¹, and the decorative layer comprises a CTE that is within 15×10⁻⁷ K⁻¹ of the CTE of the glass substrate.

An aspect (2) of the present disclosure pertains to a decorated glass article according to the aspect (1), wherein the decorated glass article comprises a probability of breakage that is less than 10% when subjected to ring-on-ring testing at a load of 60 MPa with a ring diameter of 32 mm.

An aspect (3) of the present disclosure pertains to a decorated glass article according to any of the aspects (1)-(2), wherein the CTE of the decorative layer is less than or equal to 55×10⁻⁷ K⁻¹.

An aspect (4) of the present disclosure pertains to a decorated glass article according to any of the aspects (1)-(3), wherein each of the plurality of low CTE additive component particles comprises a glass, glass frit, glass enamel, ceramic enamel, glass-ceramic or ceramic material.

An aspect (5) of the present disclosure pertains to a decorated glass article according to any of the aspects (1)-(4), wherein the decorative layer comprises greater than or equal to 20 wt % and less than or equal to 40 wt % of the low CTE additive component particles.

aspect (6) of the present disclosure pertains to a decorated glass article according to any of the aspects (1)-(5), wherein the decorative layer comprises greater than or equal to 5 wt % and less than or equal to 30 wt % of a pigment.

An aspect (7) of the present disclosure pertains to a decorated glass article according to any of the aspects (1)-(6), wherein the decorated glass article exhibits a L* value in accordance with the CIELAB color coordinate system of less than 15.0 when illuminated with a D65 illuminant from the first major surface.

An aspect (8) of the present disclosure pertains to a decorated glass article according to the aspect (7), wherein the L* value is less than or equal to 10.0.

An aspect (9) of the present disclosure pertains to a decorated glass article according to any of the aspects (1)-(8), wherein the decorated glass article exhibits an integrated visible transmittance of less than or equal to 2.0% for light from 400 nm to 700 nm that is normally incident on the first major surface in areas where the decorative layer covers the second major surface.

An aspect (10) of the present disclosure pertains to a decorated glass article according to the aspect (9), wherein the integrated visible transmittance is less than or equal to 1.0%.

An aspect (11) of the present disclosure pertains to a decorated glass article according to any of the aspects (1)-(10), wherein the decorative layer comprises an average thickness of less than or equal to 20 μm.

An aspect (12) of the present disclosure pertains to a decorated glass article according to any of the aspects (1)-(11), wherein at least one of the plurality of pores comprises a maximum diameter that is greater than 1.0 μm.

An aspect (13) of the present disclosure pertains to a decorated glass article according to any of the aspects (1)-(12), wherein the glass substrate is a curved sheet having a concave surface and a convex surface, and the decorative layer is adhered to the concave surface.

An aspect (14) of the present disclosure pertains to a decorated glass article according to any of the aspects (1)-(13), wherein the glass flux matrix comprises oxides of Bi, B, Zn, Si, or any combination thereof.

An aspect (15) of the present disclosure pertains to a decorated glass article according to any of the aspects (1)-(14), wherein: the glass substrate is formed of a borosilicate glass composition, in terms of constituent oxides, the borosilicate glass composition comprises: SiO₂, B₂O₃, Al₂O₃, one or more alkali metal oxides, and one or more divalent cation oxides selected from the group consisting of MgO, CaO, SrO, BaO, and ZnO, greater than or equal to 11 mol % and less than or equal to 16 mol % B₂O₃, greater than or equal to 2 mol % and less than or equal to 6 mol % Al₂O₃, and a total amount of Na₂O, K₂O, MgO, and CaO that is greater than or equal to 7.0 mol %, concentrations in mole percent on an oxide basis of SiO₂, B₂O₃, the one or more alkali metal oxides, Al₂O₃, and the one or more alkaline earth metal oxides, satisfy the relationships: (R₂O+R′O)≥Al2O3, 0.80< (1−[(2R₂O+2R′O)/(SiO₂+2Al₂O₃+2B₂O₃)])<0.93, and where R₂O is the sum of the concentrations of the one or more alkali metal oxides and R′O is the sum of the concentrations of the one or more alkaline earth metal oxides.

An aspect (16) of the present disclosure pertains to a decorated glass article according to any of the aspects (1)-(15), wherein the decorative layer comprises a glass softening temperature of less than or equal to 650° C.

An aspect (17) of the present disclosure pertains to a decorated glass article according to any of the aspects (1)-(16), wherein a thickness of the glass substrate ranges from 2.0 mm to 6.0 mm.

An aspect (18) of the present disclosure pertains to a glass laminate comprising a first glass substrate having a first major surface and a second major surface, the first glass substrate formed of a borosilicate glass comprising a coefficient of thermal expansion (“CTE”) that is less than or equal to 50×10⁻⁷ K⁻¹; a second glass substrate having a third major surface and a fourth major surface; an interlayer contacting the second major surface of the first glass substrate and the third major surface of the second glass substrate; and a first decorative layer adhered to at least a portion of the second major surface of the first glass substrate and contacting the interlayer, the first decorative layer comprising: a glass flux matrix, a plurality of low CTE additive component particles, and a plurality of pores, wherein: the first decorative layer comprises greater than 15 wt % of the low CTE additive component particles, each of the plurality of low CTE additive component particles comprises an additive CTE that is less than or equal to 10×10⁻⁷ K⁻¹, and the first decorative layer comprises a first CTE that is within 15×10⁻⁷ K⁻¹ of the CTE of the first glass substrate.

An aspect (19) of the present disclosure pertains to a glass laminate according to the aspect (18), wherein the second glass substrate is formed of a glass having a second composition that is different from a first composition out of which the first glass substrate is formed.

An aspect (20) of the present disclosure pertains to a glass laminate according to any of the aspects (18)-(19), wherein the second composition comprises a soda lime silicate composition, an aluminosilicate glass composition, an alkali aluminosilicate glass composition, an alkali containing borosilicate glass composition, an alkali aluminophosphosilicate glass composition, or an alkali aluminoborosilicate glass composition.

An aspect (21) of the present disclosure pertains to a glass laminate according to any of the aspects (18)-(20), wherein the first glass substrate is not chemically strengthened by ion exchange and the second glass substrate is strengthened by ion exchange.

An aspect (22) of the present disclosure pertains to a glass laminate according to any of the aspects (18)-(21), wherein the first glass substrate comprises a first thickness that is in a range from 2.0 mm to 6.0 mm and the second glass substrate comprises a second thickness that is in a range from 0.1 mm to 1.6 mm.

An aspect (23) of the present disclosure pertains to a glass laminate according to any of the aspects (18)-(22), further comprising a second decorative layer adhered to at least a portion of the third major surface of the second glass substrate and contacting the interlayer, wherein the second decorative layer comprises a second CTE that is within 10×10⁻⁷ K⁻¹ of a CTE of the second glass substrate.

An aspect (24) of the present disclosure pertains to a glass laminate according to any of the aspects (18)-(23), wherein the interlayer is disposed in at least one of the plurality of pores in the first decorative layer.

An aspect (25) of the present disclosure pertains to a glass laminate according to any of the aspects (18)-(24), wherein the first CTE of the first decorative layer is less than or equal to 55×10⁻⁷ K⁻¹.

An aspect (26) of the present disclosure pertains to a glass laminate according to any of the aspects (18)-(25), wherein each of the plurality of low CTE additive component particles comprises a glass, glass frit, glass enamel, ceramic enamel, glass-ceramic or ceramic material.

An aspect (27) of the present disclosure pertains to a glass laminate according to any of the aspects (18)-(26), wherein the first decorative layer comprises greater than or equal to 20 wt % and less than or equal to 40 wt % of the low CTE additive component particles.

An aspect (28) of the present disclosure pertains to a glass laminate according to any of the aspects (18)-(27), wherein the first decorative layer comprises greater than or equal to 5 wt % and less than or equal to 30 wt % of a pigment.

An aspect (29) of the present disclosure pertains to a glass article according to any of the aspects (18)-(28), wherein the glass laminate exhibits a L* value in accordance with the CIELAB color coordinate system of less than 15.0 when illuminated with a D65 illuminant from the first major surface.

An aspect (30) of the present disclosure pertains to a glass laminate according to any of the aspects (18)-(29), wherein the glass laminate exhibits an integrated visible transmittance of less than or equal to 2.0% for light from 400 nm to 700 nm that is normally incident on the first major surface.

An aspect (31) of the present disclosure pertains to a glass laminate according to any of the aspects (19)-(30), wherein: the first glass substrate is formed of a borosilicate glass composition, in terms of constituent oxides, the borosilicate glass composition comprises: SiO₂, B₂O₃, Al₂O₃, one or more alkali metal oxides, and one or more divalent cation oxides selected from the group consisting of MgO, CaO, SrO, BaO, and ZnO, greater than or equal to 11 mol % and less than or equal to 16 mol % B₂O₃, greater than or equal to 2 mol % and less than or equal to 6 mol % Al₂O₃, and a total amount of Na₂O, K₂O, MgO, and CaO that is greater than or equal to 7.0 mol %, concentrations in mole percent on an oxide basis of SiO₂, B₂O₃, the one or more alkali metal oxides, Al₂O₃, and the one or more alkaline earth metal oxides, satisfy the relationships: (R₂O+R′O)≥Al2O3, 0.80< (1−[(2R₂O+2R′O)/(SiO₂+2Al₂O₃+2B₂O₃)])<0.93, and where R₂O is the sum of the concentrations of the one or more alkali metal oxides and R′O is the sum of the concentrations of the one or more alkaline earth metal oxides.

An aspect (32) of the present disclosure pertains to a method of preparing a glass article, comprising: depositing onto a glass substrate a mixture containing ceramic enamel and a low CTE additive component to provide a decorative layer; and curing the decorative layer at a temperature greater than the glass softening temperature of the decorative layer to provide a cured decorative layer containing a plurality of pores and comprising a coefficient of thermal expansion (CTE) that is less than or equal to 55×10⁻⁷ K⁻¹ and within 10×10⁻⁷ K⁻¹ of the glass substrate.

An aspect (33) of the present disclosure pertains to a method according to the aspect (32), wherein the mixture comprises from 40 wt % to 85 wt % of the ceramic enamel and greater than 15 wt % of the low CTE additive component.

An aspect (34) of the present disclosure pertains to a method according to the aspect (33), wherein the mixture comprises from 20 wt % to 40% of the low CTE additive component.

An aspect (35) of the present disclosure pertains to a method according to any of the aspects (32)-(34), wherein the mixture comprises from 5 wt % to 30% of a pigment such that the cured decorative layer exhibits an L* value of less than or equal to 10.0 illuminated with a D65 illuminant.

An aspect (36) of the present disclosure pertains to a method according to any of the aspects (32)-(35), further comprising shaping the glass substrate such that the glass substrate comprises a concave surface on which the decorative layer is deposited.

An aspect (37) of the present disclosure pertains to a method according to the aspect (36), wherein the curing of the glass substrate and decorative layer occurs during the shaping.

An aspect (38) of the present disclosure pertains to a decorated glass article comprising: a glass substrate comprising a first major surface and a second major surface disposed opposite to the first major surface; and a decorative layer adhered to at least a portion of the second major surface, the decorative layer comprising: a glass flux matrix; and a plurality of pores, wherein: the decorative layer comprises a porosity that is greater than or equal to 25% and less than or equal to 30%, the glass substrate comprises a thickness that is greater than or equal to 2.1 mm, the decorative layer comprises a coefficient of thermal expansion (“CTE”) that is within 23×10⁻⁷ K⁻¹ of a CTE of the glass substrate, and the decorated glass article exhibits a B5 value of greater than or equal to 55 MPa when at least ten of the decorated glass articles are subjected to ring-on-ring strength testing according to ASTM C-1499-03.

An aspect (39) of the present disclosure pertains to a decorated glass article according to the aspect (38), wherein the glass substrate is formed of a soda lime silicate glass composition.

An aspect (40) of the present disclosure pertains to a decorated glass article according to any of the aspects (38)-(39), wherein the glass substrate is not chemically strengthened.

An aspect (41) of the present disclosure pertains to a decorated according to any of the aspects (38)-(40), wherein a difference between the CTE of the decorative layer and the CTE of the glass substrate is greater than or equal to 15×10⁻⁷ K⁻¹.

An aspect (42) of the present disclosure pertains to a decorated according to any of the aspects (38)-(41), wherein the decorative layer comprises greater than or equal to 20 wt % and less than or equal to 40 wt % of low CTE additive component particles.

An aspect (43) of the present disclosure pertains to a decorated according to the aspect (42), wherein each of the plurality of low CTE additive component particles comprises a glass, glass frit, glass enamel, ceramic enamel, glass-ceramic or ceramic material.

An aspect (44) of the present disclosure pertains to a decorated according to any of the aspects (38)-(43), wherein the decorative layer comprises greater than or equal to 5 wt % of a pigment additive.

An aspect (45) of the present disclosure pertains to a decorated according to the aspect (44), wherein the pigment additive comprises at least one of a CuCr-based pigment, a MgFe-based pigment, and a FeCrCoNi-based pigment.

An aspect (46) of the present disclosure pertains to a decorated according to any of the aspects (42)-(45), wherein the low CTE additive component particles and the pigment additive, if present, comprise an average particle size that is less than or equal to 10 μm.

An aspect (47) of the present disclosure pertains to a decorated according to any of the aspects (38)-(46), further comprising a second glass substrate and an interlayer disposed between the second glass substrate and the second major surface, wherein a polymeric material of the interlayer is present in the plurality of pores.

An aspect (48) of the present disclosure pertains to a decorated according to the aspect (47), wherein the glass article exhibits a L* value of less than or equal to 10 in areas where the decorative layer is disposed.

An aspect (49) of the present disclosure pertains to a decorated according to any of the aspects (47)-(48), when light from a D65 illuminant is reflected from the glass substrate, the light exhibits a maximum ΔE value, computed using the CIE76 formula and between two different positions of the glass article where the decorative layer is disposed, that is less than or equal to 3.0.

An aspect (50) of the present disclosure pertains to a decorated glass article according to any of the aspects (1)-(17) and (38-49), wherein the decorative layer covers greater than or equal to 5% of a total surface area of the second major surface.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. In the drawings:

FIG. 1 is an illustration of a vehicle including an automotive glazing according to one or more embodiments of the present disclosure;

FIG. 2 depicts a cross-sectional view of the automotive glazing through the line 2-2 of FIG. 1, according to one or more embodiments of the present disclosure;

FIG. 3 depicts a cross-sectional view of a curved laminate comprising a decorative layer, according to one or more embodiments of the present disclosure;

FIG. 4 depicts a flow diagram of a method of fabricating a decorated glass article and a laminate comprising the same, according to one or more embodiments of the present disclosure;

FIG. 5 is a plot containing Weibull distributions for a plurality of example decorated glass articles, according to one or more embodiments of the present disclosure;

FIG. 6 is a plot of surface height measurements used to determine a thickness of a decorative layer of an example decorated glass article, according to one or more embodiments of the present disclosure;

FIG. 7A is a scanning electron microscope image of an example decorated glass article including a porous decorative layer, according to one or more embodiments of the present disclosure;

FIG. 7B is a scanning electron microscope image of an example decorated glass article including a porous decorative layer, according to one or more embodiments of the present disclosure;

FIG. 7C is a scanning electron microscope image of an example decorated glass article including a nonporous decorative layer, according to one or more embodiments of the present disclosure;

FIG. 8 is a plot containing Weibull distributions for a plurality of example decorateds, according to one or more embodiments of the present disclosure;

FIG. 9A is a scanning electron microscope image of a non-porous decorative layer disposed on a soda lime silicate glass substrate, according to one or more embodiments of the present disclosure;

FIG. 9B is a scanning electron microscope image of a porous decorative layer disposed on a soda lime silicate glass substrate, according to one or more embodiments of the present disclosure;

FIG. 9C is a plot containing Weibull distributions for a plurality of glass articles with soda lime silicate glass substrates, according to one or more embodiments of the present disclosure

FIG. 10A is a scanning electron microscope image of a porous decorative layer disposed on a borosilicate glass substrate, according to one or more embodiments of the present disclosure;

FIG. 10B is a scanning electron microscope image of a porous decorative layer disposed on a borosilicate glass substrate, according to one or more embodiments of the present disclosure;

FIG. 10C is a plot containing Weibull distributions for a plurality of glass articles with borosilicate glass substrates, according to one or more embodiments of the present disclosure;

FIG. 11 is a scanning electron microscope image of a porous decorative layer disposed on a borosilicate glass substrate, according to one or more embodiments of the present disclosure;

FIG. 12A is a plurality of scanning electron microscope images of a plurality of glass articles with decorative layers disposed therein including varying amounts of porosity, according to one or more embodiments of the present disclosure;

FIG. 12B is a plot of B5 values for the plurality of glass articles depicted in FIG. 12A as a function of porosity of the decorative layers, according to one or more embodiments of the present disclosure;

FIG. 13A is an image of a glass article including a porous decorative layer prior to lamination with a second glass substrate via a polymer interlayer, according to one or more embodiments of the present disclosure;

FIG. 13B is an image of the glass article depicted in FIG. 13A after lamination to the second glass substrate via the polymer interlayer, according to one or more embodiments of the present disclosure;

FIG. 14A is an image of a glass article formed of a porous decorative layer comprising porosity-inducing component particles having a d50 particle size of 1.0 μm, according to one or more embodiments of the present disclosure;

FIG. 14B is an image of a glass article formed of a porous decorative layer comprising porosity-inducing component particles having a d50 particle size of 2.5 μm, according to one or more embodiments of the present disclosure;

FIG. 14C is an image of a glass article formed of a porous decorative layer comprising porosity-inducing component particles having a d50 particle size of 5.0 μm, according to one or more embodiments of the present disclosure;

FIG. 15A is a plot of Weibull B5 and scale values as a function of porosity-inducing component particle size for the examples depicted in FIGS. 14A-14C, according to one or more embodiments of the present disclosure;

FIG. 15B is a plot of Weibull B5 and scale values as a function of porosity-inducing component particle size for another set of example glass articles, according to one or more embodiments of the present disclosure;

FIG. 16 is a plot showing integrated optical transmission of samples constructed using the set of example glass articles represented in FIG. 15C both before and after lamination, according to one or more embodiments of the present disclosure;

It should be understood that numerous other modifications and examples can be devised by those skilled in the art, which fall within the scope and spirit of the principles of this disclosure.

### DETAILED DESCRIPTION

Referring generally to the figures, described herein are decorated glass articles comprising a glass substrate and a decorative layer. The decorative layer is porous (e.g., having a porosity of greater than or equal to 5%, greater than or equal to 10%, greater than or equal to 12%, greater than or equal to 14%, greater than or equal to 16%, greater than or equal to 18%, greater than or equal to 20%, greater than or equal to 21%, greater than or equal to 22%, greater than or equal to 23%, greater than or equal to 24%, greater than or equal to 25%, less than or equal to 30%). In embodiments, the glass substrate may comprise a coefficient of thermal expansion (“CTE”) that is less than or equal to 55×10⁻⁷K⁻¹ (e.g., less than or equal to 50×10⁻⁷ K⁻¹, less than or equal to 45×10⁻⁷K⁻¹, less than or equal to 40×10⁻⁷K⁻¹, less than or equal to 35×10⁻⁷K⁻¹, less than or equal to 32.5×10⁻⁷K⁻¹), a first major surface, and a second major surface that is disposed opposite to the first major surface. The decorative layer may be disposed on the second major surface of the glass substrate and cover a suitable portion of the glass substrate. In embodiments, the decorative layer can occupy an area of the surface less than 60%, 50%, 40%, 30%, 20%, 10%, 5%, 1%, 0.1%, or less than 0.01% of the total surface area of the second major surface. The decorative layer comprises a CTE that is within 23×10⁻⁷K⁻¹ of the CTE of the glass substrate such that the decorative layer does not degrade a mechanical strength of the glass substrate, despite being in contact with the glass substrate. The decorative layer may be deposited onto the second major surface of the glass substrate in a suitable pattern for decorative or concealment purposes. The relatively low CTEs of the decorative layers described herein as compared with certain existing commercially available enamels enables use of various borosilicate glasses in automotive glass applications, such as in components of automotive glazings (e.g., side windows, windshields).

When deposited on glass, such as automotive glass, the decorative layers described herein can function as a decorative enamel. Decorative enamels can serve an aesthetic purpose, a functional purpose, or both. Typically, a decorative frit will have the dual function of offering an attractive appearance and acting as a shield to block visible and UV light.

In aspects, the decorative layer is formed of a suitable ceramic enamel and low CTE additive component. Certain existing commercially available ceramic enamels are generally incompatible with low CTE glass such as borosilicate glasses because such enamels have relatively high CTEs compared with such borosilicate glasses. Such CTE differences may lead to strength degradation of the glass (such that the decorated glass article is weaker than an undecorated substrate). Accordingly, in embodiments, the decorative layer comprises at least 5 wt % (e.g., at least 10 wt %, at least 12 wt %, at least 14 wt %, at least 16 wt %, at least 18 wt %, at least 20 wt %, at least 22 wt %, at least 24 wt %, at least 26 wt %, at least 28 wt %, at least 30 wt %) of the low CTE additive component, such that a difference between a CTE of the glass substrate (CTE_{glass}) and a CTE of the decorative layer (CTE_{d}) is less than or equal to 15×10⁻⁷ K⁻¹ (e.g., less than or equal to 10×10⁻⁷ K⁻¹, less than or equal to 8×10⁻⁷ K⁻¹, less than or equal to 8×10⁻⁷ K⁻¹ less than or equal to 7×10⁻⁷K⁻¹, less than or equal to 6×10⁻⁷K⁻¹, less than or equal to 5×10⁻⁷ K⁻¹, less than or equal to 4×10⁻⁷ K⁻¹, less than or equal to 3×10⁻⁷ K⁻¹, less than or equal to 2×10⁻⁷ K⁻¹, less than or equal to 1×10⁻⁷K⁻¹, less than or equal to 0.5×10⁻⁷ K⁻¹, less than or equal to 0.1×10⁻⁷ K⁻¹, or any of the other ranges described herein). Such CTE matching may aid in preventing defects from forming in the decorative layer during fabrication of the glass article and enable the decorated glass article to exhibit favorable mechanical strength characteristics.

It has been found that the addition of the low CTE additive component to the ceramic enamels can lead to porosity in the decorative layer after the ceramic enamel is fired. The porosity has been found to prevent the decorative layer from reducing the strength of the glass substrate and, in some cases, even increase the strength of the glass substrate. The porosity is introduced during the curing process of the enamel. In embodiments, for example, the low CTE additive component (e.g., in particulate form) and a suitable medium is added to a commercially available ceramic enamel to obtain a modified enamel that can be applied to the glass substrate via a suitable application technique, and subsequently cured to form a porous structure.

In aspects, the modified enamel including any of the low CTE additive components described herein may possess various characteristics suitable for production of automotive glass. For example, in embodiments, the modified enamel is compatible with the temperatures requirement for bending and laminating the decorated glass article with another glass article in the process of forming a laminate. In embodiments, the uncured modified enamel is capable of being cured before or during a heating phase associated with bending the glass substrate into a shape suitable for a glazing application. For example, in embodiments, the modified enamel may be cured during a heating cycle of the bending process to facilitate process efficiencies. Accordingly, in embodiments, the modified enamel comprises a glass softening temperature that is less than or equal to a sagging temperature for the glass substrate. In embodiments, the glass softening temperature of the modified enamel may be less than or equal to 750° C. (e.g., less than or equal to 725° C., less than or equal to 700° C., less than or equal to 675° C., less than or equal to 650° C., less than or equal to 625° C., less than or equal to 600° C., less than or equal to 575° C., less than or equal to 550° C.) to facilitate such a simultaneous bending and curing action.

After the ceramic enamel is fired and cooled on the glass substrate, the decorative layer may comprise a thickness that is less than or equal to 30 μm (e.g., less than or equal to 25 μm, greater than or equal to 1.0 μm and less than or equal to 25.0 μm, greater than or equal to 5.0 μm and less than or equal to 25.0 μm, greater than or equal to 5.0 μm and less than or equal to 20.0 μm, greater than or equal to 5.0 μm and less than or equal to 10.0 μm). As a result of incorporating the low CTE additive component, the decorative layer may also include a porous structure. The porosity has been found to prevent the decorative layer from degrading the mechanical strength of the glass substrate. Without wishing to be bound by theory, it is believed that porosity reduces the size of areas of continuous contact between the glass substrate and the decorative enamel, which reduces CTE-induced stress buildup caused during fabrication of the decorated glass article, thereby prevent flaw formation and propagation. In embodiments, the porosity of the decorative layers described herein ranges from 5% to 40% (e.g., from 15% to 40%, from 20% to 40%, from 20% to 30%, from 25% to 30%). The porosity may also aid the decorative layer in having a desired color appearance when incorporated into a laminate. For example, in embodiments an interlayer used to attach the decorated glass substrate to another glass substrate may at least partially fill some of the pores in the decorative layer which may darken the appearance of the decorative enamel.

The decorative enamel may also comprise optical properties that are favorable for decorative automotive applications. For example, in embodiments, the decorative layer may exhibit a relatively high blackness (e.g., an L* value according to the CIELAB color coordinate system that is less than or equal to 20, less than or equal to 15, less than or equal 5, less than or equal to 2.5) at the thicknesses of less than or equal to 30 μm described herein. In embodiments, the decorative layer exhibits an integrated visible transmittance of less than or equal to 2.0% (e.g., less than or equal to 1.8%, less than or equal to 1.6%, less than or equal to 1.4%, less than or equal to 1.2%, less than or equal to 1.0%, less than or equal to 0.8%, less than or equal to 0.6%, less than or equal to 0.4%, less than or equal to 0.2%, less than or equal to 0.1%) for light from 400 nm to 700 nm that is normally incident on the glass article. Such low optical transmittance aids in the decorative layer in performing various concealment and decorative functions in automotive applications.

As used herein, the terms “optical transmission,” “percent transmission,” and “transmittance” are used interchangeably and refer to a percentage of light transmitted through an article over a wavelength range of interest. An “integrated visible transmittance” for light in a particular wavelength range is determined using the following equation:

$${T}_{int} = \frac{{\int }_{λ = 380 nm}^{780 nm} φ ( λ ) T ( λ ) d λ}{{\int }_{λ = 380 nm}^{780 nm} φ ( λ ) d λ}$$

where T(λ) represents a transmittance spectra over the wavelength range, and φ(λ) equals the transmission of the light source used to measure the transmission.

As used herein, the term “coefficient of thermal expansion” or CTE means a value obtained by measuring expansion of the referred to material between the temperatures of 25° C. and 300° C., unless expressed otherwise herein.

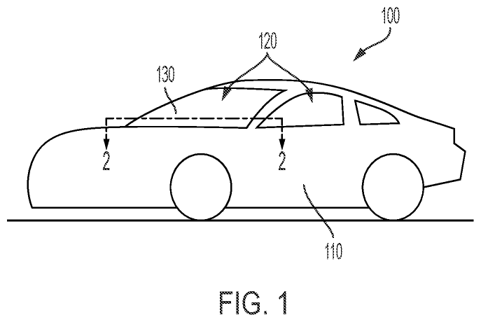

Embodiments of the decorated glass articles are described herein in relation to a vehicle 100 as shown in FIG. 1. The vehicle 100 includes a body 110 defining an interior and at least an opening 120 in communication with the interior. The vehicle 100 further includes an automotive glazing 130, i.e., window, disposed in the opening 120. The automotive glazing 130 comprises at least one ply comprising one of the decorated glass articles described herein. The automotive glazing 130 may form at least one of the sidelights, windshield, rear window, windows, and sunroofs in the vehicle 100. In some embodiments, the automotive glazing 130 may form an interior partition (not shown) within the interior of the vehicle 100, or may be disposed on an exterior surface of the vehicle 100 and form, e.g., an engine block cover, headlight cover, taillight cover, door panel cover, or pillar cover. As used herein, vehicle 100 includes automobiles (an example of which is shown in FIG. 1), rolling stock, locomotive, boats, ships, and airplanes, helicopters, drones, space craft, and the like. Further, while the present disclosure is framed in terms of a vehicle, the decorated glass articles described herein may be used in other contexts, such as in architectural glazing or bullet-resistant glazing applications.

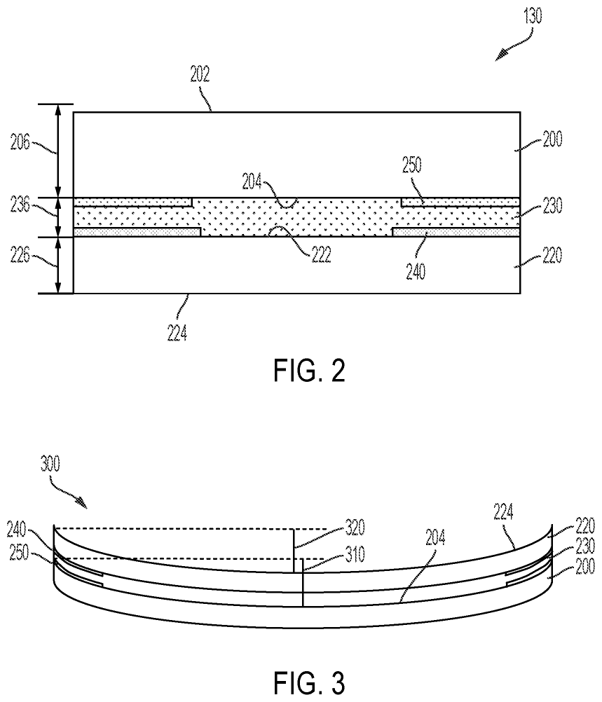

FIG. 2 schematically depicts a cross-sectional view of the automotive glazing 130 through the line 2-2 depicted in FIG. 1, according to one or more embodiments of the present disclosure. As shown, the automotive glazing 130 comprises a first glass ply 200, a second glass ply 220, and an interlayer 230 disposed between the first glass ply 200 and the second glass ply 220. As used herein, the term “glass ply” is used interchangeably with the term “glass substrate.” The first glass ply 200 comprises a first major surface 202, a second major surface 204, and a thickness 206 extending between the first major surface 202 and the second major surface 204. The second glass ply 220 comprises a first major surface 222, a second major surface 224, and a thickness 226 extending between the first major surface 222 and the second major surface 224. The interlayer 230 comprises a thickness 236 and serves to bond the first major surface 222 to the second major surface 204. In embodiments, the first major surface 202 of the first glass ply 200 forms an outer surface of the automotive glazing 130 (and faces an exterior of the vehicle 100) and the second major surface 224 of the second glass ply 220 forms an inner surface of the automotive glazing 130 (and faces an interior of the vehicle 100).

In embodiments, the first glass ply 200 comprises, consists of, or consists essentially of a borosilicate glass composition. As a result, the first glass ply 200 may comprise a first coefficient of thermal expansion that is less than or equal to 55×10⁻⁷ K⁻¹ (e.g., less than or equal to 52.5×10⁻⁷ K⁻¹ less than or equal to 50×10⁻⁷ K⁻¹, less than or equal to 47.5×10⁻⁷ K⁻¹, less than or equal to 45×10⁻⁷ K⁻¹, less than or equal to 42.5×10⁻⁷ K⁻¹, less than or equal to 40×10⁻⁷ K⁻¹, less than or equal to 37.5×10⁻⁷ K⁻¹, less than or equal to 35×10⁻⁷ K⁻¹, less than or equal to 32.5×10⁻⁷ K⁻¹, less than or equal to 32×10⁻⁷ K⁻¹). Such a CTE range may render the first glass ply 200 incompatible with decoration via existing commercially available enamels.

In embodiments, the first glass ply 200 comprises a borosilicate glass composition comprising from 60 mol % to 90 mol % SiO₂, from about 1 mol % to about 20 mol % Al₂O₃, from 7 mol % to 16 mol % B₂O₃, from 2 mol % to 20 mol % R₂O, where R₂O comprises a combined amount of Na₂O, Li₂O, and K₂O. For example, in embodiments, the borosilicate glass composition comprises about 83.60 mol % SiO₂, about 1.20 mol % Al₂O₃, about 11.60 mol % B₂O₃, about 3.00 mol % Na₂O, and about 0.70 mol % K₂O, and comprises a CTE of about 32×10⁻⁷ K⁻¹. Such borosilicate glasses may be particularly beneficial when the first glass ply 200 makes up an outer ply of the automotive glazing 130 (e.g., such that the first major surface 202 is an outer surface of the automotive glazing 130), as the borosilicate glass may have greater thermal shock resistance and be more resistant to crack formation from impact events from road debris (e.g., rocks or the like) than soda-lime silicate glasses currently used as outer plies in automotive glazings. Borosilicate glasses are known to exhibit anomalous cracking behavior and be less susceptible the formation of cracks that radially propagate from a point of debris impact, which is particularly beneficial for automotive glazing durability.

In embodiments, the first glass ply 200 particularly beneficially comprises one of the fusion-formable borosilicate glass compositions described in U.S. Provisional Patent Application No. 63/123,863, entitled “Fusion Formable Borosilicate Glass Composition and Articles Formed Therefrom” and filed on Dec. 10, 2020, U.S. Provisional Patent Application No. 63/183,271, entitled “Fusion Formable Borosilicate Glass Composition and Articles Formed Therefrom” and filed on May 3, 2021, U.S. Provisional Patent Application No. 63/183,292, entitled “Glass with Unique Fracture Behavior for Vehicle Windshield” and filed on May 3, 2021, U.S. patent application Ser. No. 17/363,266, entitled “Glass with Unique Fracture Behavior for Vehicle Windshield” and filed on Jun. 30, 2021, and International Patent Application No. PCT/US2021/061966, entitled “Glass with Unique Fracture Behavior for Vehicle Windshield” and filed on Dec. 6, 2021, the contents of each of which are hereby incorporated by reference in their entireties. In embodiments, such a borosilicate glass composition comprises, in terms of constituent oxides, SiO₂, B₂O₃, Al₂O₃, one or more alkali metal oxides, and one or more divalent cation oxides selected from the group consisting of MgO, CaO, SrO, BaO, and ZnO. In embodiments the borosilicate glass composition comprises, for example, greater than or equal to 11 mol % and less than or equal to 16 mol % B₂O₃, greater than or equal to 2 mol % and less than or equal to 6 mol % Al₂O₃, and a total amount of Na₂O, K₂O, MgO, and CaO that is greater than or equal to 7.0 mol %. Concentrations in mole percent on an oxide basis of SiO₂, B₂O₃, the one or more alkali metal oxides, Al₂O₃, and the one or more alkaline earth metal oxides, satisfy the relationships: (R₂O+R′O)≥Al and 0.80< (1−[(2R₂O+2R′O)/(SiO₂+2Al₂O₃+2B₂O₃)])<0.93, where R₂O is the sum of the concentrations of the one or more alkali metal oxides and R′O is the sum of the concentrations of the one or more alkaline earth metal oxides. Such glasses have been found to exhibit a favorable ring cracking behavior preventing radial propagation of flaws form an impact point.

In embodiments, the first glass ply 200 comprises a fusion-formable borosilicate glass composition comprising 74 mol % to 80 mol % of SiO₂, 2.5 mol % to 6 mol % of Al₂O₃, 11.5 mol % to 14.5 mol % B₂O₃, 4.5 mol % to 8 mol % Na₂O, 0.5 mol % to 3 mol % K₂O, 0.5 mol % to 2.5 mol % MgO, and 0 mol % to 4 mol % CaO (e.g., such that a combined amount of CaO and MgO is less than 5 mol %), and comprise a CTE that is greater than or equal to 32.5×10⁻⁷ K⁻¹ and less than or equal to 56×10⁻⁷ K⁻¹ (e.g., greater than or equal to 40×10⁻⁷ K⁻¹ and less than or equal to 50×10⁻⁷ K⁻¹, greater than or equal to 42×10⁻⁷ K⁻¹ and less than or equal to 48×10⁻⁷ K⁻¹, greater than or equal to 43×10⁻⁷ K⁻¹ and less than or equal to 47×10⁻⁷ K⁻¹). Such a fusion-formable glass composition may comprise concentrations in mole percent on an oxide basis of SiO₂, B₂O₃, one or more alkali metal oxides (R₂O), Al₂O₃, and one or more divalent cation oxides R′O, such that the concentrations satisfy some (e.g., one or a combination of more than one) or all the relationships: (relationship 1) SiO_{2≥72} mol %, such as SiO₂≥72.0, such as SiO₂≥73.0, such as SiO₂≥74.0, and/or SiO₂≤92, such as SiO₂≤90; (relationship 2) B₂O₃≥10 mol %, such as B₂O₃≥10.0, such as B₂O₃≥10.5, and/or B₂O₃≤20, such as B₂O₃≤18; (relationship 3) (R₂O+R′O)≥Al₂O₃, such as (R₂O+R′O)≥ (Al₂O₃+1), such as (R₂O+R′O)≥ (Al₂O₃+2), and/or (relationship 4) 0.80≤(1-[(2R₂O+2R′O)/(SiO₂+2Al₂O₃+2B₂O₃)])≤0.93, where R₂O is the sum of the concentrations of the one or more alkali metal oxides and, when included in the borosilicate glass composition, R′O is the sum of the concentrations of the one or more divalent cation oxides. R₂O may be the sum of Li₂O, Na₂O, K₂O, Rb₂O, Cs₂O for example, and R′O may be the sum of MgO, CaO, SrO, BaO, ZnO for example. Compositions meeting the relationships 1-4 described in this paragraph may tend to exhibit a unique fracture behavior where ring cracks form around a region of contact between the glass and an impactor and prevent radial crack propagation. Such fusion-formed glasses may also exhibit superior chemical durability, scratch resistance, mechanical strength, and optical performance (e.g., from both an optical transmission and optical distortion perspective) than other borosilicate glasses. Examples of such glass compositions are provided herein.

Referring still to FIG. 2, in embodiments, the second glass ply 220 comprises, consists of, or consists essentially of a second glass composition that is different from the composition of glass used to form the first glass ply 210. In embodiments, the second glass composition comprises a soda lime silicate composition, an aluminosilicate glass composition, an alkali aluminosilicate glass composition, an alkali containing borosilicate glass composition, an alkali aluminophosphosilicate glass composition, or an alkali aluminoborosilicate glass composition. In embodiments, the second glass ply 220 comprises one of the boroaluminosilicate glass compositions described in U.S. Provisional Patent Application No. 63/318,221, entitled “Boroaluminosilicate Glass Composition having High Fusion Flow Rate and Advantaged Pair Shaping Temperature” and filed on Mar. 9, 2022. In embodiments, the second glass ply 220 is formed of one of the glass compositions described in U.S. patent application Ser. No. 16/002,276, entitled “Automotive Glass Compositions, Articles, and Hybrid Laminates” and filed on Jun. 7, 2018″ or U.S. Pat. No. 10,125,044, entitled “Ion Exchangeable High Damage Resistance Glasses” and filed on Nov. 14, 2014. The content of each of these patent applications is hereby incorporated by reference in their entireties.

Irrespective of the particular composition used to form the first glass ply 200 and the second glass ply 220, embodiments are envisioned where neither of the first glass ply 200 and the second glass ply 220 are strengthened (e.g., chemically, thermally, or mechanically). Embodiments are also envisioned where at least one of the first glass ply 200 and the second glass ply is strengthened (e.g., chemically, thermally, or mechanically). In embodiments, for example, the second glass ply 220 is chemically strengthened (e.g., when constructed of a suitable alkali aluminosilicate glass composition) and the first glass ply 200 is unstrengthened (but may optionally be annealed) and exhibits a surface compressive stress of less than about 3 MPa, or about 2.5 MPa or less, 2 MPa or less, 1.5 MPa or less, 1 MPa or less, or about 0.5 MPa or less. Such embodiments may aid in reducing the weight of the automotive glazing while still providing favorable mechanical strength and meeting various regulatory requirements associated with automotive applications. Embodiments where both the first glass ply 200 and the second glass ply 220 are strengthened are also envisioned.

Thicknesses of the components of the automotive glazing 130 will now be described. In embodiments, the first thickness 206 is at least 0.5 mm, at least 1 mm, at least 2 mm, at least 3 mm, at least 3.3 mm, or at least 3.8 mm. In one or more embodiments, the first thickness is in a range from about 0.1 mm to about 6 mm, 0.2 mm to about 6 mm, 0.3 mm to about 6 mm, 0.4 mm to about 6 mm, 0.5 mm to about 6 mm, 0.6 mm to about 6 mm, 0.7 mm to about 6 mm, 0.8 mm to about 6 mm, 0.9 mm to about 6 mm, 1 mm to about 6 mm, 1.1 mm to about 6 mm, 1.2 mm to about 6 mm, 1.3 mm to about 6 mm, 1.4 mm to about 6 mm, 1.5 mm to about 6 mm, 1.6 mm to about 6 mm, from about 1.8 mm to about 6 mm, from about 2 mm to about 6 mm, from about 2.2 mm to about 6 mm, from about 2.4 mm to about 6 mm, from about 2.6 mm to about 6 mm, from about 2.8 mm to about 6 mm, from about 3 mm to about 6 mm, from about 3.1 mm to about 6 mm, from about 3.2 mm to about 6 mm, from about 3.3 mm to about 6 mm, from about 3.4 mm to about 6 mm, from about 3.5 mm to about 6 mm, from about 3.6 mm to about 6 mm, from about 3.7 mm to about 6 mm, from about 3.8 mm to about 6 mm, from about 3.9 mm to about 6 mm, from about 4 mm to about 6 mm, from about 4.2 mm to about 6 mm, from about 4.4 mm to about 6 mm, from about 4.5 mm to about 6 mm, from about 4.6 mm to about 6 mm, from about 4.8 mm to about 6 mm, from about 5 mm to about 6 mm, from about 5.2 mm to about 6 mm, from about 5.4 mm to about 6 mm, from about 5.5 mm to about 6 mm, from about 5.6 mm to about 6 mm, from about 5.8 mm to about 6 mm, from about 1.6 mm to about 5.8 mm, from about 1.6 mm to about 5.6 mm, from about 1.6 mm to about 5.5 mm, from about 1.6 mm to about 5.4 mm, from about 1.6 mm to about 5.2 mm, from about 1.6 mm to about 5 mm, from about 1.6 mm to about 4.8 mm, from about 1.6 mm to about 4.6 mm, from about 1.6 mm to about 4.4 mm, from about 1.6 mm to about 4.2 mm, from about 1.6 mm to about 4 mm, from about 1.6 mm to about 3.9 mm, from about 1.6 mm to about 3.8 mm, from about 1.6 mm to about 3.7 mm, from about 1.6 mm to about 3.6 mm, from about 1.6 mm to about 3.5 mm, from about 1.6 mm to about 3.4 mm, from about 1.6 mm to about 3.3 mm, from about 1.6 mm to about 3.2 mm, from about 1.6 mm to about 3.1 mm, from about 1.6 mm to about 3 mm, from about 1.6 mm to about 2.8 mm, from about 1.6 mm to about 2.6 mm, from about 1.6 mm to about 2.4 mm, from about 1.6 mm to about 2.2 mm, from about 1.6 mm to about 2 mm, from about 1.6 mm to about 1.8 mm, from about 3 mm to about 5 mm, or from about 3 mm to about 4 mm.

In embodiments, the thickness 226 of the second glass ply 220 is less than the thickness 206. In embodiments, the thickness is less than or equal to 2.0 mm (e.g., greater than or equal to 0.1 mm and less than or equal to 2.0 mm, greater than or equal to 0.1 mm and less than or equal to 1.8 mm, greater than or equal to 0.1 mm and less than or equal to 1.6 mm, greater than or equal to 0.5 mm and less than or equal to 1.5 mm, greater than or equal to 0.7 mm and less than or equal to 1.4 mm, greater than or equal to 0.7 mm at less than or equal to 1.2 mm, greater than or equal to 0.7 mm and less than or equal to 1.1 mm). In embodiments, the total glass thickness (i.e., the thickness 206 plus the thickness 226) is 8 mm or less, 7 mm or less, 6.5 mm or less, 6 mm or less, 5.5 mm or less, or 5 mm or less. In embodiments, the lower limit of the total glass thickness is about 2 mm.

The interlayer 230 bonds the second major surface 204 of the first glass ply 200 to the first major surface 222 of the second glass ply 220. In embodiments, the interlayer 230 comprises a polymer, such as at least one of polyvinyl butyral (PVB), acoustic PVB (APVB), an ionomer, an ethylene-vinyl acetate (EVA) and a thermoplastic polyurethane (TPU), a polyester (PE), a polyethylene terephthalate (PET), or the like. The thickness 236 of the interlayer 230 may be in the range from about 0.5 mm to about 2.5 mm, in particular from about 0.7 mm to about 1.5 mm. In other embodiments the thickness 236 may be less than 0.5 mm or more than 2.5 mm. Further, in embodiments, the interlayer 330 may comprise multiple polymeric layers or films providing various functionalities. For example, in embodiments, the interlayer 230 may incorporate at least one of a display, solar insulation, sound dampening, an antenna, an anti-glare treatment, or an anti-reflective treatment, among others. In particular embodiments, the interlayer 230 is modified to provide ultraviolet (UV) absorption, infrared (IR) absorption, IR reflection, acoustic control/dampening, adhesion promotion, and tint. The interlayer 230 can be modified by a suitable additive such as a dye, a pigment, dopants, etc. to impart the desired property.

In embodiments, at least one of the first glass ply 200 and the second glass ply 220 is provided with a functional or decorative coating in addition to the interlayer 230. Such functional or decorative coatings may be deposed any of the first major surface 202, the second major surface 204, the first major surface 222, and the second major surface 224. In embodiments, the coating is at least one of an infrared reflective (IRR) coating, frit, anti-reflective coating, or pigment coating. In an example embodiment of an IRR, the second major surface 204 of the first glass ply 310 or the first major surface 222 of the second glass ply 220 is coated with an infrared-reflective film and, optionally, one or more layers of a transparent dielectric film. In embodiments, the infrared-reflecting film comprises a conductive metal, such as silver, gold, or copper, that reduces the transmission of heat through the automotive glazing. In embodiments, the optional dielectric film can be used to anti-reflect the infrared-reflecting film and to control other properties and characteristics of the coating, such as color and durability. In embodiments, the dielectric film comprises one or more oxides of zinc, tin, indium, bismuth, and titanium, among others. In an example embodiment, the IRR coating includes one or two silver layers each sandwiched between two layers of a transparent dielectric film. In embodiments, the IRR coating is applied using, e.g., physical or chemical vapor deposition or via lamination.

In embodiments, at least one of the first glass ply 200 and the second glass ply 220 comprises a decorative layer disposed thereon. In the depicted embodiment, for example, a first decorative layer 240 is disposed on the first major surface 222 of the second glass ply 220 and a second decorative layer 250 is disposed on the second major surface 204 of the first glass ply 200. Such decorative layers may serve to protect adhesive that is used to attach the automotive glazing 130 into the opening 120 from degradation from exposure to UV light. Providing the first and second decorative layers 240 and 250 on the inner surfaces of the laminate is beneficial in that they may, for example, serve to protect IRR coatings from mechanical degradation and/or oxidation. Moreover, placement of the first and second decorative layers 240 and 250 on the second major surface 204 and the first major surface 222 may also aid in concealing any IRR films or other components (e.g., conductive elements associated with a defogging system) embedded between the first glass ply 200 and the second glass ply 220. Multiple decorative bands are particularly beneficial in providing a desired aesthetic appearance when the first glass ply 200 and the second glass ply 220 are constructed of glasses with different compositions and/or thicknesses.

As described herein, embodiments are envisioned where the first glass ply 200 and the second glass ply 220 are formed from different compositions. For example, in embodiments, the first glass ply 200 is constructed of a borosilicate glass composition comprising a CTE that is less than or equal to 55×10⁻⁷ K⁻¹ (e.g., less than or equal to 52.5×10⁻⁷ K⁻¹, less than or equal to 50×10⁻⁷ K⁻¹, less than or equal to 47.5×10⁻⁷ K⁻¹, less than or equal to 45×10⁻⁷ K⁻¹, less than or equal to 42.5×10⁻⁷ K⁻¹, less than or equal to 40×10⁻⁷ K⁻¹, less than or equal to 37.5×10⁻⁷ K⁻¹, less than or equal to 35×10⁻⁷ K⁻¹, less than or equal to 32.5×10⁻⁷ K⁻¹, less than or equal to 32×10⁻⁷ K⁻¹). In such an embodiment, the second glass ply 220 may be constructed of a soda-lime silicate glass or a chemically-strengthenable alkali aluminosilicate glass composition having a greater CTE than that of the borosilicate glass composition (e.g., greater than or equal to 60×10⁻⁷ K⁻¹, greater than or equal to 60×10⁻⁷ K⁻¹ and less than or equal to 120×10⁻⁷ K⁻¹, greater than or equal to 70×10⁻⁷ K⁻¹ and less than or equal to 120×10⁻⁷ K⁻¹, greater than or equal to 80×10⁻⁷ K⁻¹ and less than or equal to 120×10⁻⁷ K⁻¹). As such, the CTEs of the first and second glass plies 200 and 220 may differ from one another by at least 5×10⁻⁷ K⁻¹ (e.g., at least 5×10⁻⁷ K⁻¹, at least 10×10⁻⁷ K⁻¹, at least 20×10⁻⁷ K⁻¹, at least 25×10⁻⁷ K⁻¹, at least 30×10⁻⁷ K⁻¹, at least 35×10⁻⁷ K⁻¹, at least 40×10⁻⁷ K⁻¹, at least 40×10⁻⁷ K⁻¹, at least 45×10⁻⁷ K⁻¹, at least 50×10⁻⁷ K⁻¹). For example, an example is envisioned where the first glass ply 200 is constructed of a glass having a first CTE of approximately 32×10⁻⁷ K⁻¹ and the second glass ply 220 is constructed of a glass having a second CTE of approximately 90×10⁻⁷ K⁻¹. Another example is envisioned where the first glass ply 200 is constructed of a glass having a first CTE of approximately 45×10⁻⁷ K⁻¹ and the second glass ply 220 is constructed of a glass having a second CTE of approximately 90×10⁻⁷ K⁻¹.

In embodiments, it is preferred that that the first and second decorative layers 240 and 250 are constructed of materials having CTEs that are within 10×10⁻⁷ K⁻¹ of the glass plies that they are laminated to. That is, it is preferred that the first decorative layer 240 comprises a first CTE that is within 10×10⁻⁷ K⁻¹ of the CTE of the second glass ply 220 and that the second decorative layer 250 comprises a second CTE that is within 10×10⁻⁷ K⁻¹ of the CTE of the first glass ply 200. Given that the first and second glass plies 200 and 220 may be formed of glasses with substantially differing CTEs, as described herein, the first and second decorative layers 240 and 250 may be constructed of different materials.

In embodiments, the first decorative layer 240 is formed of a commercially available ceramic enamel or glass frit. In embodiments, the first decorative layer 240 is formed of a frit that is designed to be ion exchangeable. That is, the frit can be applied to an ion-exchangeable glass prior to undergoing an ion-exchange treatment. Such frit is configured to allow the exchange of ions between the glass and the treatment bath. In embodiments, the frit is a Bi—Si—B alkali system, a Zn-based Bi-system, a Bi—Zn-system, a Bi-system, an Si—Zn—B—Ti system with no or low Bi, an Si—Bi—Zn—B-alkali system, and/or an Si—Bi—Ti—B—Zn-akali system, among others. An example of an ion-exchangeable frit, including colorant, comprises 45.11 mol % Bi₂O₃, 20.61 mol % SiO₂, 13.56 mol % Cr₂O₃, 5.11 mol % CuO, 3.48 mol % MnO, 3.07 mol % ZnO, 2.35 mol % B₂O₃, 1.68 mol % TiO₂, 1.60 mol % Na₂O, 1.50 mol % Li₂O, 0.91 mol % K₂O, 0.51 mol % Al₂O₃, 0.15 mol % P₂O₅, 0.079 mol % SO₃, 0.076 mol % BaO, 0.062 mol % ZrO₂, 0.060 mol % Fe₂O₃, 0.044 mol % MoO₃, 0.048 mol % CaO, 0018 mol % Nb₂O₅, 0.006 mol % Cl, and 0.012 mol % SrO. Other examples of ion-exchangeable frits are disclosed in International Patent Application No. PCT/US2020/28176, entitled “Filled Pore Decorative Layer for Ion Exchangeable and Automotive Glass,” and filed on Apr. 15, 2022, U.S. Pat. No. 9,346,708B2 (application Ser. No. 13/464,493, filed May 4, 2012) and U.S. Publication No. 2016/0002104A1 (application Ser. No. 14/768,832, filed Aug. 19, 2015), each of which are incorporated herein by reference in their entireties.

In embodiments, the first decorative layer 240 can comprise (e.g., as an alternative or in addition to the enamel/frit-based components described in the preceding paragraph) a colorant coating comprised of an ink, such as an organic ink. In embodiments particularly suitable for such a colorant coating, the colorant coating may be applied to the first major surface 222 or the second major surface 224. Advantageously, such colorant coatings can be applied to the second glass ply 220 while the second glass ply 220 is in a planar configuration, and then the second glass ply 320 can be cold formed to a curved configuration without disrupting the colorant coating, e.g., organic ink coating. In an embodiment, the colorant coating comprises at least one pigment, at least one mineral filler, and a binder comprising an alkoxysilane functionalized isocyanurate or an alkoxysilane functionalized biuret. Examples of such colorant coatings are described in European Patent No. 2617690B1, incorporated herein by reference in its entirety. Other suitable colorant coatings and methods of applying the colorant coatings are described in U.S. Publication No. 2020/0171800A1 (application Ser. No. 16/613,010, filed on Nov. 12, 2019) and U.S. Pat. No. 9,724,727 (application Ser. No. 14/618,398, filed Feb. 10, 2015), both of which are incorporated herein by reference in their entireties.

Referring still to FIG. 2, given the relatively low CTE of the first glass ply 200, certain existing commercially available enamels are not suitable for deposition and curing thereon as the second decorative layer 250. Certain existing decorative enamels have been found to have CTEs of approximately 80×10⁻⁷ K⁻¹, or substantially different from that of the first glass ply 200 according to some embodiments described herein. Applicant has found that when deposited cured on the borosilicate glasses described herein, such existing decorative enamels exhibits cracks from the CTE mismatch, degrading the appearance and mechanical strength of the automotive glazing 130.

In view of the foregoing, the second decorative layer 250 is constructed of an enamel that has been modified through the addition of one or more low CTE additive components. As a result of the incorporation of the one or more low CTE additive components, the second decorative layer 250 may comprise a CTE (CTE_{d}) that is within 10×10⁻⁷ K⁻¹ of the CTE of the first glass ply 200 (GTE_{g}). In embodiments, 0≤|CTE_{g}−CTEₐ|≤10, 0≤|CTE_{g}−CTEₐ|≤ 9, 0≤|CTE_{g}−CTE_{d}|≤8, 0≤|CTE_{g}−CTEₐ|≤7, 0≤|CTE_{g}−CTEₐ|≤6, 0≤|CTE_{g}−CTE_{d}|≤5, 0≤|CTE_{g}−CTE_{d}|≤4, 0≤|CTE_{g}−CTEₐ≤3, 0≤|CTE_{g}−CTEₐ|≤2, 0≤|CTE_{g}−CTE_{d}|≤1, 0≤|CTE_{g}−CTE_{d}|≤0.5, 0≤|CTE_{g}−CTE_{d}|≤0.25, 0≤|CTE_{g}−CTEₐ|≤0.20, 0≤|CTE_{g}−CTEₐ|≤0.15, 0≤|CTE_{g}−CTEₐ|≤0.1, 0≤|CTE_{g}−CTE_{d}−|≤0.05. In embodiments, CTEₐ≤55×10⁻⁷ K⁻¹ (e.g., 20×10⁻⁷ K⁻¹≤CTEₐ≤55×10⁻⁷ K⁻¹, 20×10⁻⁷ K⁻¹≤CTEₐ≤50×10⁻⁷ K⁻¹, 20×10⁻⁷ K⁻¹≤CTEₐ≤45×10⁻⁷ K⁻¹, 20×10⁻⁷ K⁻¹≤CTEₐ≤40×10⁻⁷ K⁻¹, 20×10⁻⁷ K⁻¹≤CTEₐ≤35×10⁻⁷ K⁻¹, 20×10⁻⁷ K⁻¹≤CTEₐ≤32.5×10⁻⁷ K⁻¹, 35×10⁻⁷ K⁻¹≤CTEₐ≤50×10⁻⁷ K⁻¹, 40×10⁻⁷ K⁻¹≤CTEₐ≤50×10⁻⁷ K⁻¹, and any intervening ranges). As described herein, Applicant has found that constructing the second decorative layer 250 to have a CTE that approximates that of the first glass ply 200 prevents cracks from forming in the second decorative layer 250 during fabrication of the automotive glazing 130 and also prevents the incorporation of the second decorative layer 250 from degrading the mechanical strength of the first glass ply 200.

In embodiments, the second decorative layer 250 is formed by modifying a commercially available enamel via incorporation of any of the low CTE additive components described herein. In embodiments, the commercially available enamel comprises a glass or ceramic enamel comprising a glass frit component, a stain component, and optionally an additive component. The glass frit component determines various characteristics of the second decorative layer 250, including the mechanical strength and required firing conditions. In embodiments, the glass frit comprises one or more Bi, B, Zn, or Si oxides. The glass frit can be characterized by the presence of Bi, B, Zn, or Si oxides as main components. In some embodiments, the glass frit has 1 wt %, 5 wt % or 10 wt % or more of Bi, B, Zn, or Si oxide. In some embodiments, the glass frit has less than 1 mol % Na₂O, less than 10 mol % Fe₂O₃, or less than 25 mol % P₂O₅. In some embodiments, the glass frit is free of Na₂O, Fe₂O₃, or P₂O₅. In embodiments, the stain component is incorporated into the glass frit and comprises one or more Cu, Co, Fe, Ni, Mn, or Cr oxides. In some embodiments, the stain comprises non-Fe oxide, or is free of Fe oxides. Examples of suitable ceramic enamels are available from Ferro Corporation (Mayfield Heights, Ohio), including Product No. 14 316 (a bismuth-system based frit system, having a black, matte color, a wide firing range of 570-640° C. at 6 minutes, and relatively high melting point) and Product No. VPS 4100 (a black enamel which may be fired 630-650° C.). The enamel can be black, white, or any color, e.g., red, indigo, blue, green, brown, orange, violet, yellow. The commercially available enamel may be dispersed in a suitable a medium to form a paste for application to the first glass ply 200. In embodiments, the medium is constructed of an oil or organic resin suitable for drying by evaporation of solvents.

In embodiments, the low CTE additive component is added to the commercially available enamel as separate particles of a suitable low CTE material. Not only does the addition of the low CTE additive component serve to lower the CTE of the enamel, but also to add porosity to the resultant second decorative layer 250 after curing. In embodiments, the second decorative layer 250 comprises from 15 wt % to 50 wt % (e.g., from 15% to 45 wt %, from 20 wt % to 45 wt %, from 20 wt % to 40 wt %, from 25 to 45 wt %, from 25 wt % to 40 wt %) of the low CTE additive component after curing, such that the second decorative layer 250 comprises from 40 wt % to about 85 wt % (e.g., from 50 wt % to 85 wt %, from 50 wt % to 80 wt %, from 50 wt % to 75 wt %, from 50 wt % to 70 wt %) of the enamel. The enamel can be about 40 wt %, 45 wt %, 50 wt %, 55 wt %, 60 wt %, 65 wt %, 70 wt %, 75 wt %, 80 wt %, or 85 wt % of the second decorative layer 250.

Prior to curing, the second decorative layer 250 may comprise a mixture of ceramic enamel and low CTE additive component particles. In embodiments, the low CTE additive component particles comprise an average particle size that is less than or equal to 100 μm (e.g., less than or equal to 50 μm, less than or equal to 40 μm, less than or equal to 30 μm, less than or equal to 20 μm). It has been found that the size of the additive particles influences the porosity of the second decorative layer 250 after curing. The low CTE additive component particles prevents densification of the enamel around them during sintering, leading to a porous structure.

In embodiments, the low CTE additive component is present as filler particles in the second decorative layer 250. The material out of which the low CTE additive component is formed may have a melting point or softening temperature that is greater than that associated with the frit component in the enamel.

Various suitable materials for the low CTE additive component particles are contemplated within the scope of the present disclosure. In embodiments, the low CTE additive component comprises a CTE that is less than or equal to 10×10⁻⁷ K⁻¹ (e.g., less than or equal to 5×10⁻⁷ K⁻¹, less than or equal to 0×10⁻⁷ K⁻¹, less than or equal to −5×10⁻⁷ K⁻¹, less than or equal to −10×10⁻⁷ K⁻¹, less than or equal to −50×10⁻⁷ K⁻¹, less than or equal to −100×10⁻⁷ K⁻¹). It has been found that the CTE of the second decorative layer 250 after curing is roughly a weighted average of all of the constituent components. Accordingly, the CTE of the particular CTE additive component (or combination of multiple components) selected determines the weight percentage needed to achieve a desired CTE. In embodiments, the refractive index of the low CTE additive component is greater than or equal to 1.5 and less than or equal to 1.6. In embodiments, the refractive index of the low CTE additive component is greater than 1.6. A higher refractive index may be preferred to maintain higher opacity of the decorative layer.

In embodiments, the low CTE additive component comprises a ceramic or glass-ceramic material having a CTE in any of the ranges described herein. One example ceramic is a β-eucryptite ceramic 118VTC developed by Corning® incorporated, which has a CTE that approximately equal to −10×10⁻⁷ K⁻¹. Another example ceramic is an aluminum titanate ceramic, which has a CTE of less than less than −10×10⁻⁷ K⁻¹. A suitable glass-ceramic material is KeraBlack® plus ceramic sold by EuroKera S.N.C., which as a CTE of approximately 0×10⁻⁷ K⁻¹. In embodiments, the low CTE additive component comprises a negative CTE. Such negative CTE materials may include Bi—Ni—Fe-oxides, Zr—W-oxides, and other suitable materials.

In addition to CTE, the low CTE additive component may be selected such that the resultant second decorative layer 250 has a desired opacity. The low CTE additive component, for example, may be selected to absorb light (e.g., at least 50% of light, at least 60% of light, at least 70% of light, at least 80% of light, at least 90% of light) in the visible spectrum (averaged). In embodiments, the low CTE additive component is selected such that the second decorative layer 250 exhibits a high blackness (e.g., comprises a L* value of less than or equal to 20, less than or equal to 18, less than or equal to 16, less than or equal to 14, less than or equal to 13, less than or equal to 12, less than or equal to 10, less than or equal to 8, less than or equal to 6, less than or equal to 5) when illuminated by a D65 illuminant at a 0° illumination angle. L* values described herein assume a 2° standard observer.

In embodiments, when only modified through the addition of the low CTE additive component alone, the enamel may exhibit a darkness that is outside of this range. For example, the 118VTC ceramic described above tends to exhibit a white color and a low refractive index. In such a case, particles of a suitable pigment may be further added to the enamel to provide a desired appearance. In embodiments, the pigment particles are added in an amount that is less than or equal to that of the low CTE additive component. The pigment may also be incorporated into the base ceramic enamel (e.g., as a stain component). In embodiments, the pigment, if included, is added such that the pigment is present in an amount that is greater than or equal to 0 wt % and less than or equal to 50 wt % of the second decorative layer 250, when cured (e.g., greater than or equal to 0 wt % and less than or equal to 40 wt %, greater than or equal to 0 wt % and less than or equal to 30 wt %, greater than or equal to 5 wt % and less than or equal to 30 wt %, greater than or equal to 5 wt %, and less than or equal to 20 wt %). Examples of suitable pigment include B1G pigment, 30C965 (a CuCr-based pigment), and 20F944 (a MgFe-based pigment) from Shepherd (Cincinnati, Ohio) and V7709 (a CuCr-based pigment) and 240137 (a FeCrCoNi-based pigment) from Ferro Corporation (Mayfield Heights, Ohio). Pigments can be black, blue, green, brown, orange, violet, yellow, or metallic variants thereof. In various embodiments, the pigments are the same or similar color as the enamel (e.g., the pigment and enamel may exhibit a* and b* values, when illuminated with a D65 illuminate at a 0° illumination angle, that differ from one another by less than 5).

In embodiments, Pigments are selected which have the following primary-components in order to obtain desired color, for example as follows: black (CuCrFe, CrFe, manganese ferrite spinel, FeCrCoNi), blue (Cobalt aluminate, cobalt chromite spinel, CoZnCrAl), green (Cobalt titanate green spinel), brown (Manganese antimony titanium buff rutile, zinc iron chromite brown spinel, iron titanium brown spinel), orange (Rutile tin zinc), violet (Cobalt phosphate), yellow (Nickel antimony titanium yellow rutile, niobium sulfur tin zinc oxide), and metallic aspect (Mica flakes covered with titanate, titanate and tin oxide, or iron oxide).

Applicant has found that the introduction of the low CTE additive component and pigments (if included) to the enamel introduces a certain level of porosity into the second decorative layer 250 after curing. The level of porosity is influenced by frit composition, particle size, amount of added low CTE additive component and pigment, and the firing temperature. Without wishing to be bound by theory, it is believed a greater amount of low CTE additive component or lower firing temperature will result in increased porosity. As described herein, it has been found that at least some porosity in the second decorative layer 250 is helpful in increasing a mechanical strength of the automotive glazing 130, especially when a CTE of the second decorative layer 250 differs from that of the first glass ply 200 by at least 5×10⁻⁷ K⁻¹ (such as when 5≤|CTE_{g}−CTEₐ|≤10). It is believed that the porosity beneficially aids in reducing thermally-induced stresses caused by the CTE mismatch, thereby reducing the probability of cracks and improving adhesion and mechanical durability. Porosity can be measured, for example, by use of a scanning electron microscope (SEM) and comparing the proportion of a surface occupied by pores to the total surface. In various embodiments, the porous inorganic layer can have a porosity of at least or about 15%, 20%, 40%, 50%, 60%, or greater (e.g., from 25% to 30%).

Relatively high levels of porosity in the second decorative layer 250 may tend to degrade the cohesion of the second decorative layer 250 to the first glass ply 200, which may reduce scratch resistance and depth of color. It has been observed, for example, that when the second decorative layer 250 is porous, the second decorative layer 250 may exhibit a grey appearance after firing, even when the enamel is initially black. It has been found that this greyness is reduced after lamination via interaction with the material of the interlayer 230 (e.g., the polymeric material may at least partially flow into some of the pores during lamination, causing the automotive glazing 130 to have a desired appearance).

While the embodiment depicted in FIG. 2 illustrates the automotive glazing 130 as a flat structure (e.g., where the first and second glass plies 200 and 220 are planar in shape), it should be understood that embodiments where the automotive glazing 130 comprises a curved shape are also contemplated and within the scope of the present disclosure. In embodiments, the automotive glazing 130 exhibits at least one curvature comprising a radius of curvature that is in the range of 300 mm to about 10 m along at least a first axis. In embodiments, the automotive glazing 130 exhibits at least one curvature comprising a radius of curvature that is in the range of 300 mm to about 10 m along a second axis that is transverse, in particular, perpendicular to the first axis.

In embodiments, curvature(s) are introduced into at least one of the first glass ply 200 and the second glass ply 220 through a thermal process. The thermal process may include a sagging process that uses gravity to shape the first glass ply 200 or the first and second glass plies 200 and 220 when heated. In the sagging step, a glass ply, such as the first glass ply 200, is placed on a mold having an open interior, heated in a furnace (e.g., a box furnace, or a lehr furnace), and allowed to gradually sag under the influence of gravity into the open interior of the mold. In one or more embodiments, the thermal process may include a pressing process that uses a mold to shape the first glass ply 200 or the first and second glass plies 200 and 220 when heated or while heating. In some embodiments, two glass plies, such as the first and second glass plies 200 and 220 are shaped together in a “pair-shaping” process. In such a process, one glass ply is placed on top of another glass ply to form a stack (which may also include an intervening release layer), which is placed on the mold. In embodiments, to facilitate the pair-shaping process, the second glass ply 220, used as an inner and/or thinner glass ply in some embodiments, has a pair-shaping temperature (temperature at 1011 Poise) that is greater than that of the first glass ply 200.

In one or more embodiments, the mold used during pair sagging may have an open interior for use in a sagging process. The stack and mold are both heated by placing them in the furnace, and the stack is gradually heated to the bend or sag temperature of the glass plies. During this process, the plies are shaped together to a curved shape. Advantageously, the viscosity curve for at least some of the borosilicate glass composition comprised herein at a viscosity of 1011 Poise is similar that of the glass used in the second glass ply 220, allowing for existing equipment and techniques to be utilized.

According to an exemplary embodiment, heating time and temperature are selected to obtain the desired degree of curvature and final shape. Subsequently, the glass ply or glass plies are removed from the furnace and cooled. For pair-shaped glass plies, the two glass plies are separated, re-assembled with an interlayer, such as interlayer 230, between the glass plies and heated, e.g., under vacuum to seal the glass plies and interlayer together into a laminate.

In embodiments, only one glass ply (e.g., the first glass ply 200) is curved using heat (e.g., by a sag process or press process), and the other glass ply (e.g., the second glass ply 220) is curved using a cold-forming process by pressing the glass ply to be curved into conformity with the already curved glass ply at a temperature less than the softening temperature of the glass composition (in particular at a temperature of 200° C. or less, 100° C. or less, 50° C. or less, or at room temperature). Pressure to cold-form the glass ply against the other glass ply may be provided by, e.g., a vacuum, a mechanical press, or one or more clamps. The cold-formed glass ply may be held into conformity with the curved glass ply via the interlayer and/or mechanically clamped thereto or otherwise coupled.

In embodiments, the modified enamel that is cured into the second decorative layer 250 described herein is deposited onto the first glass ply 200 prior to the first glass ply 200 being bent. As described herein, the enamel used to form the second decorative layer 250 may comprise a softening temperature that is less than or about equal to 700° C., 650° C., 600° C., 570° C., 550° C., 525° C., 500° C., 475° C., or about equal to 450° C. Typical bending temperatures used for the first glass ply 200 (e.g., temperature at 1011 Poise) may be greater than or equal to the softening temperature associated with the enamel in the second decorative layer 250. As such, the enamel may be fired during the bending process and fused to the second major surface 204 to form the second decorative layer 250, thereby providing process efficiencies.

FIG. 3 depicts an exemplary embodiment of a curved glass laminate 300. The curved glass laminate 300 is similar in structure to the automotive glazing 130 described herein with respect to FIGS. 1-2, as indicated by the incorporation of like reference numerals. As can be seen in FIG. 3, the second major surface 204 of the first glass ply 200 has a first curvature depth 310 defined as the maximum depth from planar (dashed line) of the second major surface 204. In embodiments in which the second glass ply 220 is curved, the second major surface 224 of the second glass ply 220 has a second curvature depth 320 defined as the maximum depth from planar (dashed line) of the second major surface 224.

In embodiments, one or both the first curvature depth 310 and the second curvature depth 320 is about 2 mm or greater. Curvature depth may be defined as maximum distance a surface is distanced orthogonally from a plane defined by points on a perimeter of that surface. For example, one or both the first curvature depth 310 and the second curvature depth 320 may be in a range from about 2 mm to about 30 mm. In embodiments, the first curvature depth 310 and the second curvature depth 320 are substantially equal to one another. In one or more embodiments, the first curvature depth 310 is within 10% of the second curvature depth 320, in particular within 5% of the second curvature depth 320. For illustration, in an example where the second curvature depth 320 is about 15 mm, the first curvature depth 310 may be range from about 13.5 mm to about 16.5 mm (or within 10% of the second curvature depth 320).

In embodiments, the first curvature depth 310 is induced in the first glass ply 200 by hot forming (e.g., the first glass ply 200 may be bent by gravity sagging), and the second curvature depth 320 is induced in the second glass ply 220 by cold forming. In embodiments, the first and second curvature depths 310 and 320 are induced by hot-bending the first and second glass plies 200 and 220 (e.g., in a co-bending process or in a process where the plies are bent independently from one another).

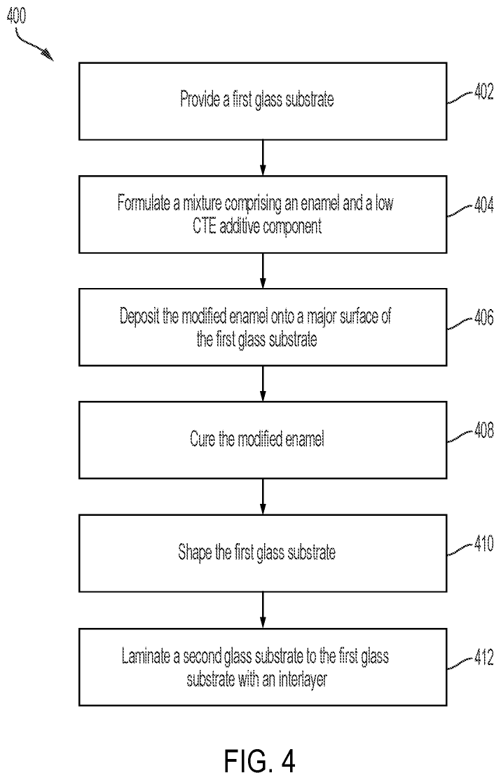

Referring now to FIG. 4, a flow diagram of a method 400 of fabricating a glass laminate is shown, according to an example embodiment of the present disclosure. For example, the method 400 may be used to fabricate the curved glass laminate 300 described herein with respect to FIG. 3. Accordingly, various components depicted in FIGS. 2-3 will be referred to aid in describing the method. It should be understood that alternative methods may be used to form the curved glass laminate 300. Moreover, the method 400 may be used to form laminates other than the curved glass laminate 300.

At block 402, a first glass substrate is provided. The first glass substrate may take the form of the first glass ply 200, as described herein with respect to FIG. 2. For example, the first glass substrate, as initially provided, may take the form of a planar glass sheet comprising one of the borosilicate glass compositions described herein. The first glass substrate may be fabricated or commercially purchased. Any suitable glass forming technique may be used to fabricate the first glass substrate. The glass forming technique used may depend on the borosilicate glass composition, as some compositions may not be compatible with certain glass-forming techniques. Embodiments are contemplated, however, where the first glass substrate is formed by a suitable down-draw or float process. The first glass substrate may be formed to have a thickness within any of the ranges described herein with respect to the first glass ply 200.

At block 404, a mixture is formulated for the second decorative layer 250 to be deposited directly on the second major surface 204. The mixture may comprise an enamel (e.g., a ceramic enamel) comprising a glass or ceramic frit, a stain component, and optional additives, dispersed in a suitable medium. The enamel may comprise a formulation described herein with respect to the second decorative layer 250. The enamel (prior to being cured) may be modified through the addition of any of the low CTE additive components described herein in combination with additional medium. Any of the glass-ceramics or ceramics described herein may be mixed with the uncured enamel in a suitable proportion such that the second decorative layer 250, after the enamel is cured, comprises a CTE within the ranges described herein that substantially matches that of the first glass substrate. A pigment may also be added to the enamel in the event that the low CTE additive component introduces an undesired color.

When the low CTE additive component is added to the mixture, dispersion equipment with a toothed blade rotating at an initial rate (e.g., between 1000 and 2000 rpm) may be used to mix the enamel. After the low CTE additive component is added to the enamel, additional medium may be added to the mixture to control viscosity. The additional medium may be the same medium as that incorporated into the original enamel, and be added to the formulation at an equivalent weight to the low CTE additive component and any pigment to keep the overall solid content in the formulation close to the original enamel. After the addition of the medium, the toothed blade may be rotated at an increased rate (e.g., at least 8000 rpm) for at least 10 minutes to obtain correct dispersion of the additional components. Tank temperature should be maintained less than 40° C. to avoid solvent evaporation or medium degradation. After dispersion, the fineness of grind is controlled using a Hegman gauge and may be less than or equal to a target value given for the original enamel. The final viscosity of the modified enamel may range from 500 mPa·s to 50,000 mPa·s (e.g., approximately 10,000 mPa·s) as measured at a 5s⁻¹ shear rate using a rheometer, and therefore compatible with screen printing application methods.

At block 406, the modified enamel is deposited onto the second major surface 204 of the first glass ply 200. The deposition may use any suitable technique (e.g., screen printing, spraying, brushing, banding), with the understanding that viscosity adjustments may be needed (e.g., via additions of water or additional medium) depending on the deposition technique selected. At block 408, the modified enamel is cured on the first glass ply 200 by heating to a suitable firing temperature (e.g., at least the softening temperature associated with the enamel) to dissolve the solvent and solidify the glass frit into a glass fuse matrix surrounding the low CTE additive component. At block 410, the first glass ply 200 is shaped. In embodiments, the blocks 408 and 410 occur simultaneously, as the modified enamels described herein are beneficially compatible with hot-bending techniques and may be cured as the first glass ply 200 is heated to a forming temperature in a furnace with suitable shaping equipment (e.g., bending ring or mold).

At block 412, a second glass substrate is laminated to the first glass substrate via an interlayer. For example, in embodiments, the second glass ply 220 having any of the compositions described herein may be provided having a planar shape. The second glass ply 220 may be pressed against the first glass ply 200 with the interlayer 230 therebetween and, as pressure is applied, the stack may be heated to a glass transition temperature associated with the material of the interlayer 230 and subsequently cooled, causing the interlayer 230 to solidify and attach the first glass ply 200 to the second glass ply 220, so that the second glass ply 220 is retained in a curved shape that matches that of the first glass ply 200. In this example, the second glass ply 220 may already have the first decorative layer 240 formed thereon prior to lamination to the first glass ply 200. In embodiments, for example, the first decorative layer 240 may be formed of a commercially available enamel applied to the second glass ply 220 when flat. In another example, both the first and second glass plies 200 and 220 may be hot formed (e.g., co-sagged simultaneously, or curved separately). Embodiments are also envisioned where one or more of the first and second decorative layers 240 and 250 are deposited on a curved surface (e.g., after the first and second glass plies 200 and 220 are shaped).

With reference to FIG. 2, various example compositions of borosilicate glasses included in the first glass ply 200 will now be described. Examples 1-6 are described in terms of composition and various properties in the Table 1 below.

TABLE 1

| Example | 1 | 2 | 3 | 4 | 5 | 6 |
|---|---|---|---|---|---|---|
| SiO₂ | 75.35 | 76.72 | 76.14 | 75.18 | 77.19 | 76.36 |
| Al₂O₃ | 3.54 | 3.54 | 3.54 | 4.07 | 4.04 | 4.07 |
| B₂O₃ | 12.21 | 10.75 | 11.31 | 12.01 | 9.84 | 10.86 |
| Na₂O | 4.60 | 4.67 | 4.68 | 4.61 | 4.70 | 4.57 |
| K₂O | 2.13 | 2.18 | 2.18 | 2.93 | 3.05 | 2.94 |
| MgO | 0.99 | 0.99 | 0.99 | 0.02 | 0.02 | 0.02 |
| CaO | 1.03 | 1.02 | 1.02 | 1.05 | 1.03 | 1.03 |
| SnO₂ | 0.14 | 0.13 | 0.13 | 0.13 | 0.13 | 0.14 |
| Density (g/cm³) | 2.307 | 2.308 | 2.308 | 2.316 | 2.335 | 2.324 |
| Strain Point (° C.) | 512.6 | 518.6 | 516.7 | 515.2 | 528.0 | 520.7 |
| LTCTE | 5.1 | 5.24 | 5.1 | 5.58 | 5.55 | 5.56 |
| (ppm/° C.) | | | | | | |
| HTCTE | 25.44 | 25.26 | 24.79 | 24.52 | 24.6 | 24.58 |
| (ppm/° C.) | | | | | | |
| Young's | 66.6 | 67.7 | 67.1 | 66.7 | 69.2 | 67.7 |
| Modulus (GPa) | | | | | | |
| Poisson's Ratio | 0.198 | 0.194 | 0.196 | 0.200 | 0.194 | 0.197 |
| Fulchers A | −1.531 | −1.342 | −1.536 | −1.163 | −1.159 | −1.152 |
| Fulchers B | 5661.3 | 5468.2 | 5817.5 | 4739.4 | 4858.6 | 4848.7 |
| Fulchers T₀ | 140.9 | 182.3 | 142.8 | 227.7 | 232.4 | 224.8 |
| 200 P Temp (° C.) | 1618 | 1683 | 1659 | 1596 | 1637 | 1629 |
| 35 kP Temp (° C.) | 1073 | 1111 | 1100 | 1058 | 1084 | 1076 |
| 200 kP Temp | 970 | 1005 | 994 | 961 | 985 | 976 |
| (° C.) | | | | | | |
| Liquidus | 947 | 672 | 1578 | 3779 | 2892 | 4013 |
| Viscosity (kP) | | | | | | |

As shown in the Table 1, the glass compositions each exhibit a low temperature coefficient of thermal expansion (LTCTE), which was obtained by measuring expansion of the glass between 0° C. and 300° C., of 5.6 ppm/° C. or less, in particular, 5.3 ppm/° C. or less, and particularly 5.1 ppm/° C. or less.

Additional example borosilicate glass compositions are described in the Table 2 below.

TABLE 2

| Example | 7 | 8 | 9 | 12 | 13 | 14 |
|---|---|---|---|---|---|---|
| SiO₂ | 76.75 | 75.93 | 76.38 | 76.34 | 76.06 | 76.15 |
| Al₂O₃ | 3.57 | 3.53 | 3.56 | 3.56 | 3.54 | 3.54 |
| B₂O₃ | 11.18 | 11.61 | 12.26 | 11.80 | 12.43 | 12.89 |
| Na₂O | 6.35 | 4.59 | 4.87 | 4.29 | 4.15 | 3.85 |
| K₂O | 2.04 | 2.13 | 1.01 | 1.96 | 1.95 | 1.80 |
| MgO | 0.00 | 0.03 | 1.81 | 0.95 | 0.86 | 0.82 |
| CaO | 0.01 | 2.05 | 0 | 0.99 | 0.90 | 0.86 |
| SnO₂ | 0.11 | 0.11 | 0.11 | 0.10 | 0.10 | 0.10 |
| Density | 2.328 | 2.32 | 2.273 | 2.298 | 2.285 | 2.271 |
| (g/cm³) | | | | | | |
| Strain Point | 518.6 | 525.8 | 506.2 | 512.7 | 511.1 | 506.6 |
| (° C.) | | | | | | |
| Anneal Point | 564 | 571.4 | 552.9 | 558.7 | 558.2 | 554.9 |
| (° C.) | | | | | | |
| LTCTE | 5.6 | 5.15 | 4.58 | 4.8 | 4.6 | 4.5 |
| (ppm/° C.) | | | | | | |
| Young's | 68.7 | 68.3 | 63.1 | 65.9 | 64.6 | 63.0 |
| Modulus | | | | | | |
| (GPa) | | | | | | |
| Poisson's | 0.192 | 0.192 | 0.196 | 0.196 | 0.2 | 0.2 |
| Ratio | | | | | | |
| Fulchers A | −1.121 | −0.974 | −1.682 | −1.504 | −1.647 | −1.835 |
| Fulchers B | 4505.1 | 4545.6 | 6535.2 | 12 | 13 | 14 |
| Fulchers T₀ | 255.8 | 251.8 | 69 | 76.34 | 76.06 | 76.15 |
| 200 P Temp | 1572 | 1640 | 1710 | 1676 | 1695 | 1718 |
| (° C.) | | | | | | |
| 35 kP Temp | 1051 | 1076 | 1119 | 1097 | 1113 | 1121 |
| (C) | | | | | | |
| 200 kP Temp | 957 | 976 | 1005 | 987 | 1002 | 1005 |
| (° C.) | | | | | | |
| Liquidus | 582 | 855 | 1365 | 1021 | 1197 | 1752 |
| Viscosity | | | | | | |
| (kP) | | | | | | |

As shown in the Table 2, examples 12-14 demonstrate that the increasing amount of B₂O₃ can have the effect of decreasing density. The above examples include at least 5.5 mol % of Na₂O+K₂O and a total of at least 7.0 mol % of Na₂O+K₂O+MgO+CaO. From the examples in Tables 1-2, it is believed that embodiments of the present disclosure will exhibit a T_{200P} and liquidus viscosity for fusion forming where a total amount of Na₂O+K₂O+MgO+CaO is at least 7.0 mol %, especially where there is at least 5.5 mol % of Na₂O+K₂O and at least 1.5 mol % of MgO+CaO. It is further believed that embodiments of the present disclosure will exhibit the requisite T_{200P} and liquidus viscosity for fusion forming where Na₂O+K₂O is at least 8 mol % without regard to the amount of MgO and CaO.

Iron may also be added to the borosilicate glass composition to provide desired optical transmission performance for automotive glazing applications. Examples incorporating various amounts of iron are shown in the Table 3 below. Any of the examples described in any of the following patent applications: U.S. Provisional Patent Application No. 63/123,863, entitled “Fusion Formable Borosilicate Glass Composition and Articles Formed Therefrom” and filed on Dec. 10, 2020, U.S. Provisional Patent Application No. 63/183,271, entitled “Fusion Formable Borosilicate Glass Composition and Articles Formed Therefrom” and filed on May 3, 2021, U.S. Provisional Patent Application No. 63/183,292, entitled “Glass with Unique Fracture Behavior for Vehicle Windshield” and filed on May 3, 2021, U.S. patent application Ser. No. 17/363,266, entitled “Glass with Unique Fracture Behavior for Vehicle Windshield” and filed on Jun. 30, 2021, and International Patent Application No. PCT/US2021/061966, entitled ““Glass with Unique Fracture Behavior for Vehicle Windshield” and filed on Dec. 6, 2021, may be used in the first glass ply 200 in various embodiments.

TABLE 3

| Example | 15 | 16 | 17 | 18 | 19 | 20 | 21 | 22 |
|---|---|---|---|---|---|---|---|---|
| SiO₂ | 76.00 | 76.16 | 76.06 | 76.04 | 76.22 | 75.93 | 75.68 | 75.93 |
| Al₂O₃ | 3.53 | 3.54 | 3.53 | 3.54 | 3.55 | 3.52 | 3.51 | 3.46 |
| B₂O₃ | 11.58 | 11.41 | 11.26 | 11.34 | 11.25 | 11.29 | 12.55 | 12.65 |
| Na₂O | 4.58 | 4.52 | 4.65 | 4.57 | 4.45 | 4.57 | 4.2 | 5.20 |
| K₂O | 2.11 | 2.12 | 2.18 | 2.11 | 2.07 | 2.14 | 2.05 | 0.92 |
| MgO | 0.98 | 0.97 | 0.97 | 0.98 | 0.98 | 0.98 | 0.85 | 1.74 |
| CaO | 1.01 | 1.03 | 1.03 | 1.03 | 1.02 | 1.03 | 0.9 | 0 |
| Fe₂O₃/FeO | 0.07 | 0.15 | 0.22 | 0.28 | 0.37 | 0.44 | 0.16 | 0.04 |
| SnO₂ | 0.11 | 0.11 | 0.11 | 0.11 | 0.10 | 0.10 | 0.1 | 0.06 |
| Refractive | 1.4855 | 1.4855 | 1.4855 | 1.4855 | 1.4855 | — | 1.484 | — |
| Index at | | | | | | | | |
| 633 nm | | | | | | | | |

As exemplified by the above examples, in embodiments the borosilicate glass compositions that form the first glass ply 200 comprise SiO₂ in an amount in a range from 72 mol % to 80 mol % (e.g., from 74 mol % to 80 mol %), B₂O₃ in an amount in a range from 10 mol % to 20 mol % (e.g., from 11 mol % to 20 mol %, from 11 mol % to 16 mol %), Al₂O₃ in an mount in a range from 2 mol % to 6 mol % (e.g., from 2.5 mol % to 5 mol %, from 3 mol % to 5 mol %), Na₂O in an amount in a range from 3 mol % to 8 mol % (e.g., from 4 mol % to 8 mol %, from 4.5 mol % to 6.5 mol %), K₂O in an amount less than the amount of N₂O (e.g., such that a ratio of K₂O to N₂O ranges from 0.1 to 0.75, or from about 0.1 to about 0.45), and a total amount of MgO and Currently Amended) that is less than or equal to 5 mol %. In embodiments, the amount of Na₂O may exceed the amount of Al₂O₃ by at least 1.0 mol % (e.g., at least 1.25 mol % or at least 1.5 mol %). This combination of compositional amounts may aid the first glass ply 200 in being formed via fusion forming techniques (and therefore obtaining optical distortion performance benefits and scratch resistance associated with that forming technique), while being stable in formation and having desired chemical and mechanical durability characteristics.

### EXAMPLES

Embodiments of the present disclosure may be further understood in view of the following examples.

In the following examples, commercially available enamels from Ferro Corporation were modified by incorporating low CTE additive components. The starting materials in the following Examples are described in the Table 4 below.

TABLE 4

| Product | Manufacturer | Ingredient |
|---|---|---|
| Black Enamel VPS 4100 | Ferro Corporation | Ceramic Enamel |
| Black Enamel No. 14316 | Ferro Corporation | Ceramic Enamel |
| Borosilicate glass | Corning | Glass Substrate |
| | Incorporated | (see Example 22) |
| B1G, copper chromite | Shepherd | Pigment |
| black spinel | | |

Five examples (Examples 23-28 and 31) were formulated as described in the Table 5 below. The examples were flat glass substrates with a decorative layer of the presented composition deposited thereon in accordance with the method 400 described herein with respect to FIG. 4. The borosilicate glass composition used in the following examples exhibited a CTE (25-300° C.) of about 45×10⁻⁷ K⁻¹. Each of the Examples 23-28 exhibited a porosity of from 25% to 30%.

TABLE 5

| Example | 23 | 24 | 25 | 26 | 27 | CE1 | CE2 | 31 |
|---|---|---|---|---|---|---|---|---|
| Starting Enamel | 14316 | VPS | VPS | VPS | VPS | VPS | 14316 | 14316 |
| | | 4100 | 4100 | 4100 | 4100 | 4100 | | |
| Additives (wt %) | 30% | 30% | 40% | 25% | 25% KB + | 15% | 15% KB + | 30% |
| | 118VTC | 118VTC | 118VTC | 118VTC | 20% B1G | 118VTC | | 118VTC |
| | | | | 20% B1G | | | | 5% B1G |
| Thickness after | 20 | 13 | 19 | 18 | 10 | 12 | 12 | ~30 |
| firing (μm) | | | | | | | | |
| CTE (25-300° C.) | 48 | 42 | 34 | 50 | 50 | 53 | 69 | 47.6 |
| (×10⁻⁷ K⁻¹) | | | | | | | | |
| Weibull Scale (MPA) | 97 | 72 | 81 | 85 | 103 | 31 | 30 | 76 |
| Weibull Slope | 17 | 7 | 22 | 14 | 7 | 6 | 13 | 13 |
| B10 (MPa) | 85 | 60 | 75 | 73.87 | 80 | 23.47 | 29 | 65 |
| Integrated Visible | 1.9 | | | 1 | 1.5 | | | 0.0 |
| Transmission (%) | | | | | | | | |
| (before lamination) | | | | | | | | |
| Integrated Visible | 1.8 | | | 0.9 | 1.2 | | | 0.0 |
| Transmission (%) | | | | | | | | |
| (after lamination) | | | | | | | | |
| L* value | 10.3 | | | 3.1 | 11.7 | | | 7.7 |
| Porous? | Y | Y | Y | Y | Y | N | Y | Y |

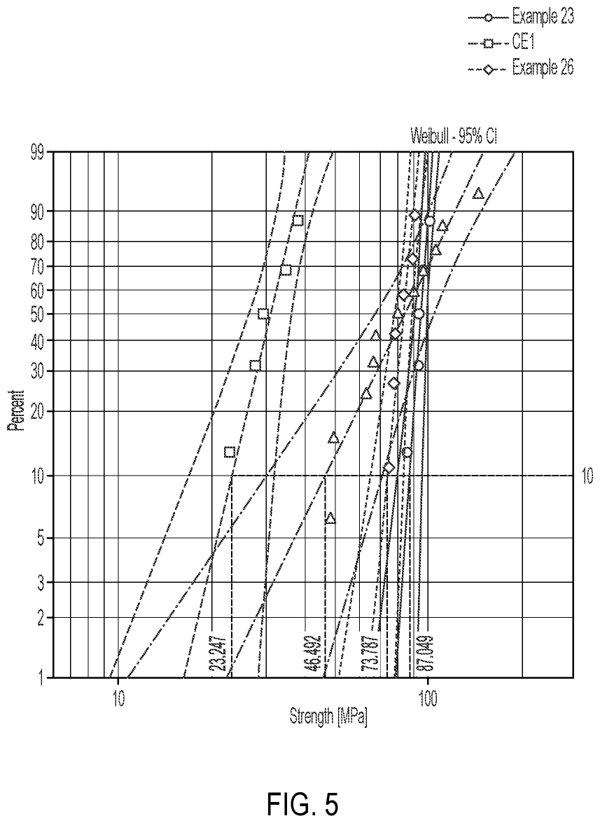

For each of the Examples described in the Table 5, mechanical performances were measured via ring-on-ring (ROR) testing with a diameter of 32 mm and a glass thickness of 3.8 mm. ROR testing was performed according to the ASTM C-1499-03 standard test method for Monotonic Equibiaxial Flexural Strength of Advanced Ceramics at Ambient Temperatures. Weibull distributions were calculated for each of the samples. The Weibull distribution results for some of the examples are depicted in FIG. 5. As shown, Examples 23 and 26 surprisingly exhibited mechanical performances that were superior to a bare glass substrate (having the same composition but with no decorative layer disposed thereon). As shown, the Weibull slope for each of Examples 23 and 26 was less than that of the bare glass substrate. Moreover, as can be seen from the Table 5 above, each of Examples 23-27 and 31 exhibited a B10 value (a mechanical load where the breakage probability is 10%) of greater than or equal to 60 MPa, while the bare glass substrate exhibited a B10 value of about 47 MPa. The glass substrates decorated with the enamels of the present disclosure unexpectedly exhibited higher mechanical strength (as indicated by the higher B10 values), as well as superior reliability (as indicated by the smaller Weibull slope parameter) than the bare substrate. In embodiments, when glass substrates of the glass articles described herein have thicknesses that are greater than or equal to 2.1 mm, the decorated glass articles exhibited B10 values that are greater than or equal to 60 MPa (e.g., greater than or equal to 65 MPa, greater than or equal to 70 MPa, greater than or equal to 75 MPa, greater than or equal to 80 MPa, greater than or equal to 85 MPa).

As shown in FIG. 5, the counterexample CE1 exhibited inferior mechanical performance to the Examples 23-27 and bare glass substrate. While the CTE of the counterexample CE1 was relatively low and within 10×10⁻⁷ K⁻¹ of the glass substrate, it is believed that the relatively low mechanical strength was due to a lack of porosity in the decorative layer. It is believed that little porosity was observed in the decorative layer for the counter example CE1 due to the relatively low amount of low CTE additive component that was added (the decorative layer only comprised 15 wt % of the low CTE additive component). Accordingly, in embodiments, the decorative layers of the glass articles described herein may comprise at greater than 15 wt % of the low CTE additive component (e.g., greater than or equal to 16 wt %, greater than or equal to 17 wt %, greater than or equal to 18%, greater than or equal to 19 wt %, greater than or equal to 20 wt %, greater than or equal to 21 wt %, greater than or equal to 22 wt %, greater than or equal to 23 wt %, greater than or equal to 24 wt %, greater than or equal to 25 wt %, greater than or equal to 20 wt % and less than or equal to 50 wt %, greater than or equal to 20 wt % and less than or equal to 45% wt %, greater than or equal to 25 wt % and less than or equal to 45 wt %, greater than or equal to 30 wt % and less than or equal to 40 wt %, and any intervening ranges). It is believed that this amount of low CTE additive component provides a decorative layer in the desired CTE range, while still inducing porosity into the decorative layer for superior mechanical strength attributes.

With reference to the Table 5, CTEs of the enamels were measured on sintered pellets of modified enamels. In order to measure CTE, a thin layer of enamel was put onto a glass ceramic sample and placed in an oven for few hours (120° C.) to remove the solvent. After complete evaporation of the solvent, the enamel turned into dried powder. It was then crushed in an agate bowl to get a fine powder. The powder is compacted into a small pellet using a pelletizer and sintered for 7 min at 625° C. The CTE is measured using TMA on the sintered pellet. This measurement was done using TMA Q400 EM from TA Instruments. As shown in the Table 5, each of the Examples 23-27 exhibited a CTE of less than or equal to 50×10⁻⁷ K⁻¹. The CTE of each decorative layer according to the Examples ranged from 34×10⁻⁷ K⁻¹ to 50×10⁻⁷ K⁻¹. The Examples 23 and 24 comprised CTE values that were closest to that of the glass substrate. Example 23 exhibited the highest B10 value, while Example 24 exhibited the lowest Weibull slope.

The color of each of Examples 23, 26, and 27 was measured by illumination of the samples with a D65 illuminant at a 10° observer angle. The integrated visible transmittance over the visible spectrum was also measured for each of these examples. As shown, for each of these examples, the L* value was less than 15, and, in some cases, even less than 10, or even less than 5. The integrated visible transmittance before lamination was less than or equal to 2.0%, in some cases less than or equal to 1.5%, and in some cases less than or equal to 1.0%. After lamination, the integrated visible transmittance was slightly less than before lamination as a result of the PVB interlayer filling at least some of the pores in the decorative layer. The laminates were a 0.7 mm thick inner ply of aluminosilicate glass, a 0.76 mm thick PVB interlayer, and a 3.8 mm outer glass ply of a borosilicate glass composition described herein. The decorative layer was disposed on the outer ply adjacent the interlayer.

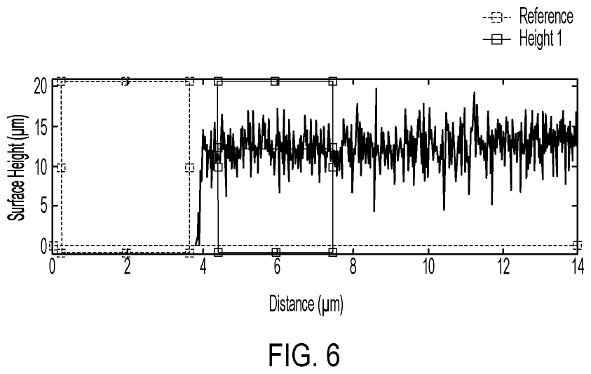

Thicknesses of the decorative layer of each of the Examples was measured using a 2 mm confocal sensor of the Altisurf™ 100. Profiles were generated using the MountainsMap® software with the following metrological filters: a polynomial degree of 3 was used to remove shape defects and a Gaussian robust filter was used to remove measurement artifacts. An example thickness profile for the counterexample CE2 is shown in FIG. 6, which resulted in a measured thickness value of 12.24 μm. As shown, the surface height deviates about the obtained average as a result of the porosity in the decorative layer.

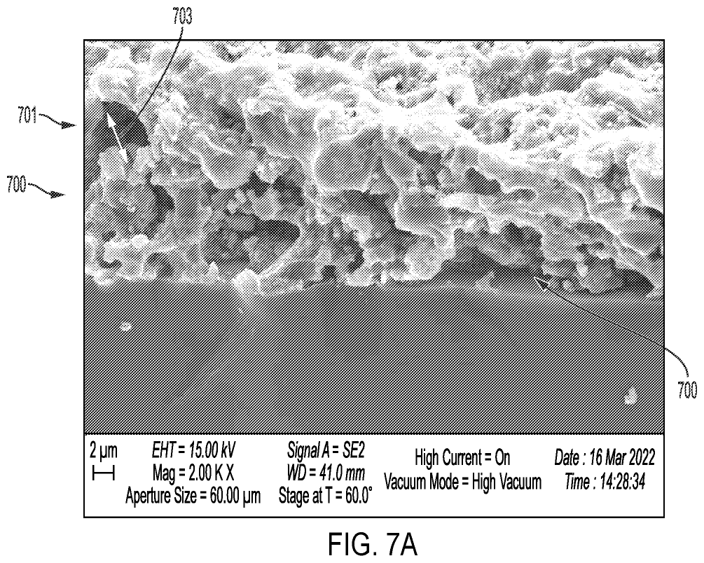

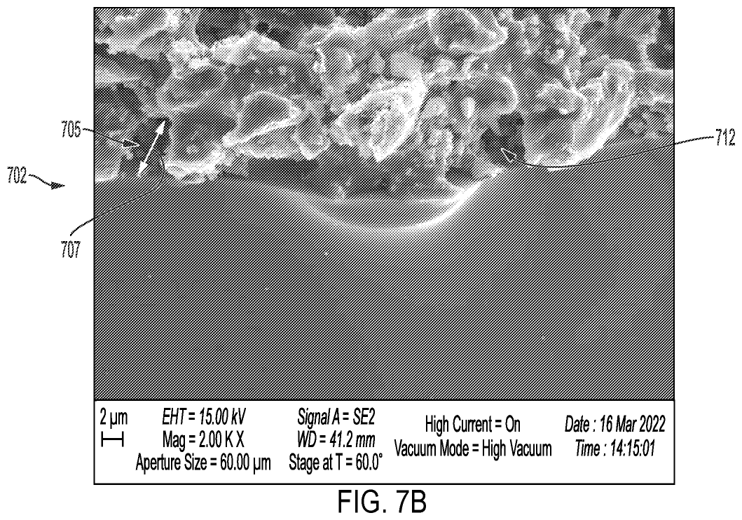

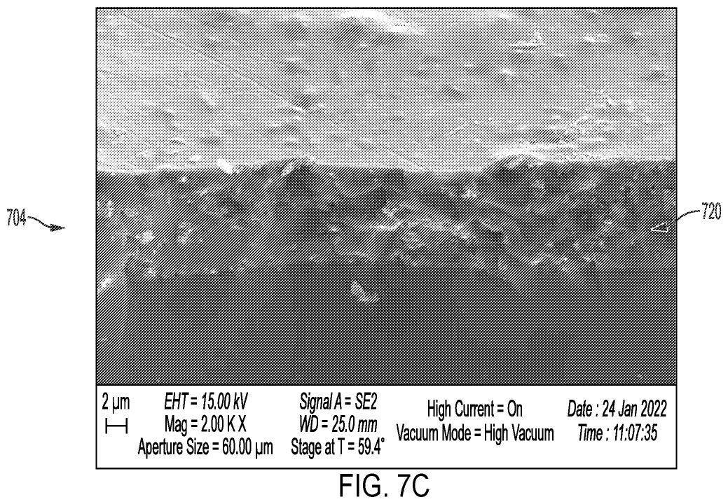

FIGS. 7A, 7B, and 7C depict scanning electron microscopy images for Example 23, Example 26, and counterexample CE1. FIG. 7A is an image 700 of the Example 23. FIG. 7B is an image of the Example 26. FIG. 7C is an image of the counterexample CE1. As shown, each of Examples 23 and 26 exhibit porosities, with each containing pores of having a maximum diameter greater than 1.0 μm. Both of Examples 23 and 26 exhibit pores with maximum pore diameters of greater than 2.0 μm. As shown in FIG. 7A, Example 23 comprises a pore 701 with a maximum diameter 703 of approximately 4.0 μm. As shown in FIG. 7B, Example 26 comprises a pore 705 with a maximum diameter 707 of approximately 5.0 μm. As described herein, “maximum diameter” refers to a length of the longest straight line that is contained in a volume of a pore without intersecting a pore boundary. Ends of such maximum diameters may also occur at the glass substrate surface.

As shown in FIGS. 7A-7B, each of Examples 23 and 26 exhibit pores (e.g., voids that are devoid of the material of the decorative layer) at the interface between the glass substrate and the decorative layer (Example 23 includes an interface pore 710 and Example 26 includes an interface pore 712). That is, in these examples, the interface between the glass substrate and the decorative layer does not include a continuous contact area between the glass and cured enamel, but rather discontinuous regions of contact. Breakages in contact area between the glass substrate and decorative layer may aid in providing the decorated glass articles with superior mechanical strength performance.

Referring to FIG. 7C, the counterexample C1 comprised a nonporous decorative layer 720 that lacked any pores having a maximum diameter of greater than 1.0 μm. As a result, the interface between the glass substrate and nonporous decorative layer 720 was a continuous contact area between the glass and the material of the decorative layer. It is believed that such continuous contact degrades mechanical strength of the glass substrate by increasing the likelihood of crack formation in the decorative layer, leading to more defects.

In order to investigate the relationship between decorative layer and porosity, additional example decorative layers were formed on soda-lime silicate glass substrates. The glass substrates in these examples comprised CTEs of about 90×10⁻⁷ K⁻¹. Three examples were formulated, the details of which are provided in the Table 6 below.

TABLE 6

| | Example | | |
|---|---|---|---|
| | 28 | 29 | 30 |
| Frit | NA | 14316 | 14316 |
| Fillers | NA | NA | 15% B1G |
| CTE (25-300°) | NA | 80 | 84 |
| (×10⁻⁷ K⁻¹) | | | |
| Weibull Scale | 155 | 65 | 106 |
| Weibull Slope | 3 | 6.3 | 5.5 |
| B10 (MPa) | 70 | 51 | 79 |
| Porous? | NA | N | Y |

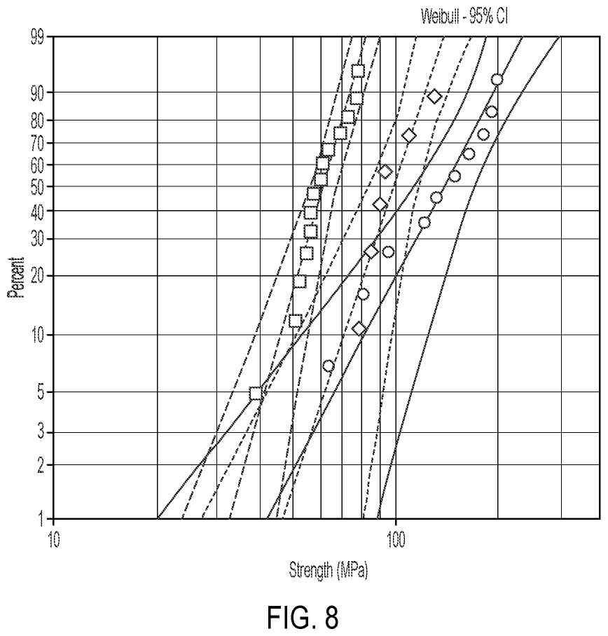

As shown in the Table 6, Example 28 consisted of a bare glass substrate, Example 29 comprised a glass substrate decorated with a commercial enamel to provide a nonporous decorative layer, and the Example 30 comprised a glass substrate with a modified decorative enamel with pigment additive to provide a porous decorative layer. ROR testing was conducted for each sample and the results are depicted in FIG. 8. As shown, the porous enamel exhibits a higher B10 value than the nonporous example. Moreover, the deposition of the enamel appears to result in a higher slope of the Weibull distribution, demonstrating improved reliability. The Example 30 achieved superior performance over the Example 29 in terms of B10 value, indicating the favorability of a porous decorative layer.

Embodiments of the present disclosure may be further understood in view of the following information.

The decorative layers described herein can generally include a base enamel (e.g., comprising one or more of any of the glass frit components, stain components, and additive components described herein) and one or more porosity-inducing components, such as any of the low CTE additive components described herein (e.g., a β-eucryptite phase of LiALSiO₄), other filler such as alumina, zeolite, and/or a pigment additive that facilitates development of porosity in the decorative layer after curing. In embodiments, it is preferrable that the decorative layers develop a porosity of greater than or equal to 5% after curing (e.g., greater than or equal to 10%, greater than or equal to 15%, greater than or equal to 20%, greater than or equal to 25%, greater than or equal to 30%). The porosity may be determined by SEM image analysis, averaging over four images at different, non-overlapping locations from the same sample. When measuring porosity of the examples described herein, each image in the SEM measurement captured a length of about 55 μm of the decorative layer. It has been found that decorative layers exhibiting such a porosity may be printed on glass substrates with a difference in CTE (ACTE) of up to approximately 23×10⁻⁷ K⁻¹ while still providing acceptable mechanical strength results. In embodiments, the glass articles described herein including a porous decorative layer can achieve a B5 value that is greater than or equal to 45 MPa (e.g., greater than or equal to 50 MPa, greater than or equal to 55 MPa, greater than or equal to 60 MPa, greater than or equal to 65 MPa, greater than or equal to 70 MPa, or even greater than or equal to 75 MPa) when incorporated into various laminate constructions, provided that the preceding porosity and ΔCTE requirements are met.

Even with such porosity present in the decorative layers described herein, it has been found that the glass articles described herein exhibit a desirable opaque appearance. In embodiments, after lamination, the glass articles described herein exhibit a CIELAB L* value that is less than or equal to 12 (e.g., less than or equal to 11, less than or equal to 10, less than or equal to 9, less than or equal to 8, less than or equal to 7) in areas where the interlayer material (e.g., a polymeric interlayer such as PVB) fills at least some of the pores in the decorative layer as a result lamination. The glass articles described herein may also exhibit a maximum ΔE value, computed using the CIE76 formula and between two different positions on the article where the decorative layer is disposed and at least partially fills the pores, that is less than or equal to 3.0 (e.g., less than or equal to 2.5, less than or equal to 2.0, less than or equal to 1.5, less than or equal to 1.0). In embodiments, glass articles exhibit (in regions where the decorative layer is disposed) an integrated visible transmittance (either before or after lamination) of less than or equal to 2.0% (e.g., less than or equal to 1.8%, less than or equal to 1.6%, less than or equal to 1.4%, less than or equal to 1.2%, less than or equal to 1.0%, less than or equal to 0.8%, less than or equal to 0.6%, less than or equal to 0.4%, less than or equal to 0.2%, less than or equal to 0.1%) for light from 400 nm to 700 nm that is normally incident on the glass article. As such, after lamination, the decorateds provide a desirable opaque, uniform appearance that aids in concealing various components that may be disposed behind the glass articles (such as in an automotive obscuration).

In embodiments, the decorated articles described herein may include one or more regions where the pores in the decorative layer are not filled by polymeric material of an interlayer (e.g., the glass article may not be a laminate or the interlayer material may not flow into the pores during lamination). Such regions may exhibit L* values that are less than or equal to 30 and may provide a wide variety of appearances that may be desired for a particular application.

In aspects, the glass articles described herein pass standard weathering tests for automotive industry, such as the bake test, boil test, and UV resistance, according to the standard ANSI Z26. To facilitate passage of such tests, outer edges of the porous decorative layer may be encapsulated in polymeric material of an interlayer material when a decorated glass article is incorporated into a laminate.

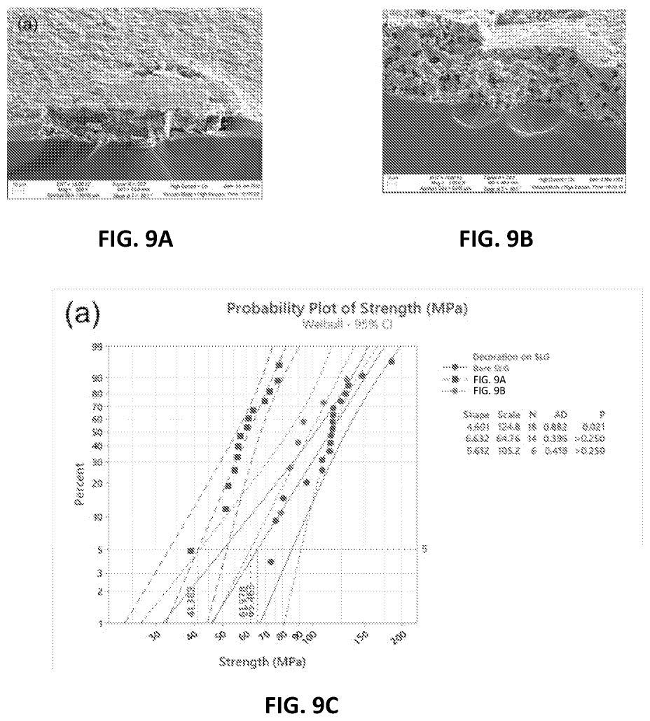

To further understand performance attributes of the decorative layers described herein, additional examples were constructed and analyzed for various mechanical and optical performance properties. A first set of examples were constructed on 2.1 mm thick sheets of soda lime glass. FIG. 9A depicts an example glass article with a non-porous decorative layer (having the same composition as the decorative layer described above with respect to Example 29). In the example depicted in FIG. 9A, the non-porous decorative layer exhibited a ΔCTE of about 10×10⁻⁷K⁻¹) with the glass. FIG. 9B depicts an example glass article with a porous decorative layer (having the same composition as the decorative layer described above with respect to Example 30). In the example depicted in FIG. 9B, the porous decorative layer exhibited a ΔCTE of about 5×10⁻⁷K⁻¹) with the glass (the porosity was less than 20%, but greater than 5%).

The examples depicted in FIGS. 9A and 9B, as well as a bare soda lime glass substrate, underwent ROR testing with a diameter of 32 mm and according to the ASTM C-1499-03. The results are depicted in FIG. 9C. As shown, consistent with the results described above with respect to Examples 28, 29, and 30, the example with the porous decorative layer exhibited mechanical strength that is superior to that of the example with the non-porous decorative layer. Indeed, the bare substrate exhibited a B5 value of 65 MPa, the example with the non-porous decorative layer exhibited a B5 value of 41 MPa, and the example with the porous decorative layer exhibited a B5 value of 62 MPa. These results indicate that the porous decorative layer unexpectedly did not significantly hinder the mechanical strength of the glass substrate. Indeed, the sample with the porous decorative layer exhibited a B5 value of greater than or equal to 45 MPa, indicating that the decorative layers described therein provide superior mechanical performance as compared to certain existing decorative materials. The porosity in the decorative layer resulted in a mechanical strength degradation of less than 10% when compared to a bare, undecorated substrate, or even improved the mechanical strength results. Such results indicate that porous decorative layers may find use even when used to decorate glass substrates that are not chemically strengthened, such as soda lime silicate glass compositions in automotive glazings (e.g., the soda lime glass may be used as an exterior and/or interior ply in a glazing and be decorated by one of the decorative layers described herein).

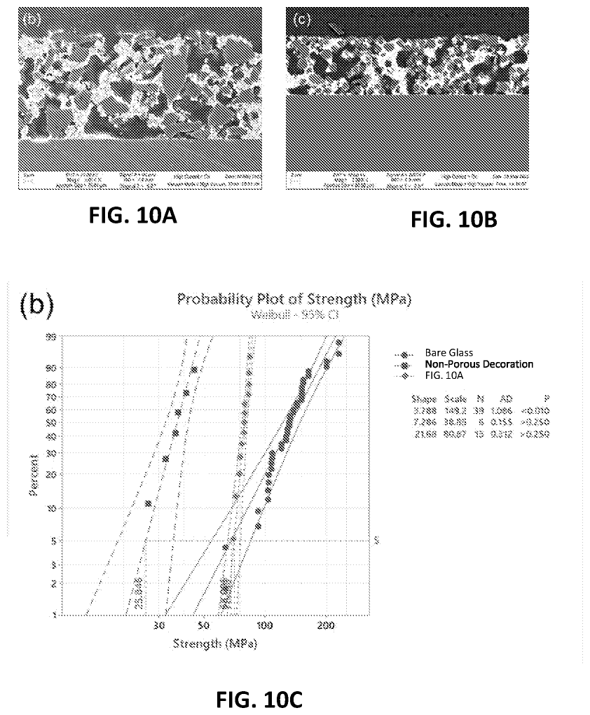

An additional set of example decorative layers were formed on 3.8 mm thick glass substrates formed of the borosilicate glass composition described herein with respect to Example 22 (comprising a CTE of about 45.2×10⁻⁷K⁻¹). FIG. 10A depicts a first porous decorative layer on the borosilicate glass. The first porous decorative layer had the same composition as the decorative layer in Example 31 herein. The first porous decorative layer had a ΔCTE with the glass substrate of about 3×10⁻⁷K⁻¹. FIG. 10B depicts a second porous decorative layer on the borosilicate glass. The second porous decorative layer contained a base enamel of Ferro 13316 and 25 wt % zeolite as porosity-inducing component. The second porous decorative layer had a ΔCTE with the glass substrate of about 23×10⁻⁷K⁻¹. Both examples exhibited a porosity between 25% and 30%.

The examples depicted in FIGS. 10A and 10B were subjected to ROR testing via the same method as described above with respect to FIGS. 9A and 9B. A bare substrate of the borosilicate glass was also tested. A glass substrate decorated with a non-porous decorative layer (comprised of a base enamel of Ferro 14316 with 15 wt % 118VTC particles) was also tested. The results for the example depicted in FIG. 10A, the bare substrate, and the non-porous decorative layer are shown in FIG. 10C. As shown, the example with the porous decorative layer exhibited mechanical strength that is superior to that of the example with the non-porous decorative layer. Indeed, the bare substrate exhibited a B5 value of 68 MPa, the example with the non-porous decorative layer exhibited a B5 value of 26 MPa, and the example with the porous decorative layer exhibited a B5 value of 71 MPa. The example depicted in FIG. 10B was also tested and exhibited a B5 value of 85 MPa. Unexpectedly, the decorative layer with the zeolite additive exhibited superior mechanical strength results despite a relatively high ΔCTE with the glass substrate of 23×10⁻⁷K⁻¹. Such results unexpectedly demonstrate that porous decorative layers with a ΔCTE of greater than or equal to 10.0 (e.g., greater than or equal to 11.0, greater than or equal to 12.0, greater than or equal to, 13.0, greater than or equal to 14.0, greater than or equal to 14.0, greater than or equal to 15.0, greater than or equal to 16.0, greater than or equal to 17.0, greater than or equal to 18.0, greater than or equal to 19.0, greater than or equal to 20.0, greater than or equal to 21.0, greater than or equal to 22.0, greater than or equal to 23.0) with respect to the glass substrate may be used while still exhibiting acceptable mechanical performance.

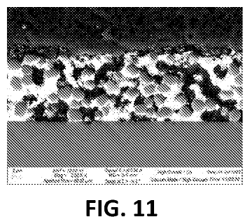

A further porous decorative layer comprised of Ferro 14316 as a base enamel modified with 35 wt % alumina particles as a porosity-inducing component was constructed on the borosilicate glass according to Example 22 (with a 3.8 mm thickness). That example is depicted in FIG. 11. The porous decorative layer exhibited a porosity of about 30% and a ΔCTE with the glass substrate of about 30×10⁻⁷K⁻¹. ROR strength testing was conducted in a manner consistent with the other examples and the example depicted in FIG. 11 was determined to exhibit a B5 value of about 24 MPa, which was similar to the example with the non-porous decorative layer. These results demonstrate that the porosity may be insufficient to overcome relatively high ΔCTE values of greater than or equal to 30×10⁻⁷K⁻¹.

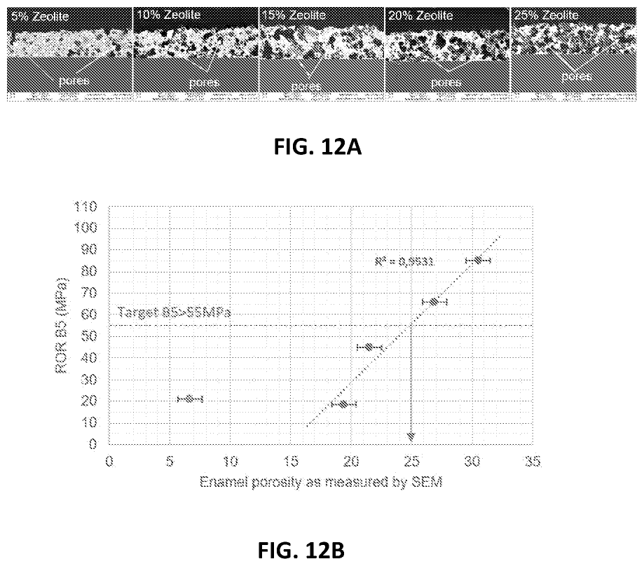

To determine a desired amount of porosity for the decorative layers described herein, a plurality of samples were constructed on the borosilicate silicate glass composition described herein with respect to Example 22. The samples had porous decorative layers formed using varying amounts of Zeolite ZSM-5 as the porosity-inducing component. The zeolite particles had a particle size (d50) between 2.5 μm and 3.0 μm. Each of the samples is depicted in FIG. 12A. As shown, the porosity in the decorative layer tends to increase in proportion to the amount of zeolite added. The samples were subjected to ROR testing using a method consistent with the other examples. B5 values for each of the samples were determined and plotted as a function of porosity of each of the samples. The results are depicted in FIG. 12B. As shown, decorative layers having porosities between 6.7% and 18.5% exhibited relatively low B5 values of less than 25 MPa. When the porosity was above 18.5%, the B5 values increased quasi-linearly as a function of porosity. As such, for these particular examples, it was determined that decorative layers exhibiting a porosity of at least 25% likely exhibit a target B5 value of at least 55 MPa. This is despite the example with 25 wt % zeolite in the decorative layer still exhibiting a ΔCTE of about 23×10⁻⁷K⁻¹ with the glass substrate. It is believed that zeolite being a porous filler (with the zeolite particles themselves containing pores ranging in size from 1 nm to 10 nm) may contribute to these favorable results.

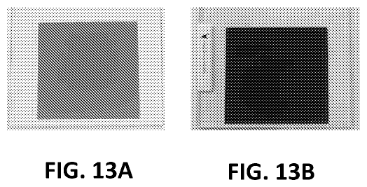

FIG. 13A depicts an example porous decorative layer on a borosilicate glass substrate prior to lamination. As shown, when viewed from the glass side, this example exhibits a gray appearance (with a L* value of about 30). FIG. 13B depicts the same example after lamination with another glass substrate via a PVB interlayer. In these examples, the borosilicate glass was 3.8 mm and the interlayer material was a PVB layer having a thickness of 0.76 mm. Interlayer material was applied between the decorated borosilicate glass substrate and an aluminosilicate glass substrate having a thickness of 0.7 mm. The stack was deaired at 118° C. at a pressure of 0.95 bar and subsequently heated in an autoclave to 140° C. at 13 bar. As shown, during lamination, the interlayer material flows into the pores of the decorative layer and darkens the appearance of the article. After lamination, when viewed from the same glass side as in FIG. 13A, the article exhibits a L* value of less than 8, which is desirable for automotive applications. This example demonstrates how the porous decorative layers described herein can achieve favorable appearance attributes despite the porosity therein.

In embodiments, the porous decorative layers described herein can cover at least 5% (e.g., at least 6%, at least 7%, at least 8%, at least 9%, at least 10%, at least 15%, at least 20%, at least 25%, or greater than or equal to 10% and less than or equal to 30%) of a total surface area of the glass article (of the major surface on which it is disposed). For example, in automotive applications, the glass article may have a surface area (e.g., measured on the external surface) of at least 0.25 m² (e.g., at least 0.5 m², at least 0.75 m², at least 1.0 m², at least 1.5 m², at least 2.0 m², at least 2.5 m²). As such, the porous decorative layer may cover a surface area of at least 0.00125 m². In embodiments, the glass article may have a surface area of greater than or equal to 2.0 m² and the porous decorative layer may have a surface area of at least 0.1 m² or at least 0.2 m². The surface area covered by the decorative layer may extend around a periphery of the glass article (e.g., from proximate or at a peripheral edge of the glass article inward to form a decorated boundary of the glass article on the major surface). Despite the porous decorative layer covering such a large area, the glass articles may exhibit the mechanical strength attributes described herein.

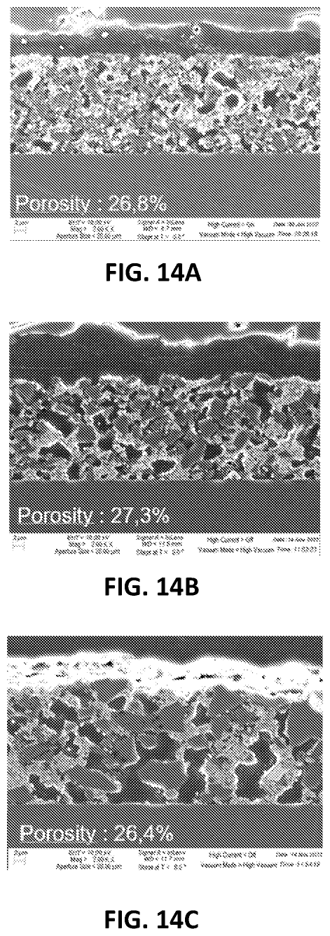

Further samples were constructed to determine the influence of the porosity-inducing component particle size. A first set of samples was formed using a decorative layer having the composition described with respect to Example 31 herein were formed with varying d50 particles sizes for the 118 VTC additive. A first example included wet milled and dried 118 VTC to provide a d50 particle size of 1 μm, which is depicted in FIG. 14A. A second example included jet milled 118 VTC to provide a d50 particle size of 2.5 μm, which is depicted in FIG. 14B. A third example included jet milled 118 VTC to provide a d50 particle size of 5 μm, which is depicted in FIG. 14C. The first example had a porosity of about 26.8%. The second example had a porosity of about 27.3%. The third example had a porosity of about 26.4%. As shown, decreasing the porosity-inducing component (or low CTE additive component in this case) particle size reduces the average pore size while keeping the overall porosity relatively constant.

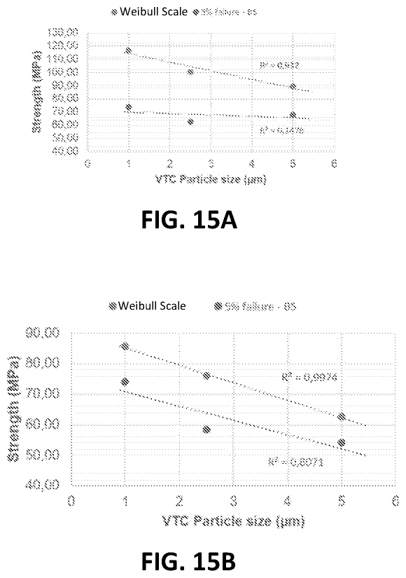

ROR testing was conducting in a manner consistent with the other examples with these decorative layers being deposited on a borosilicate glass article having a thickness of 3.8 mm. B5 values as well as Weibull scale values are plotted as a function of d50 particle size in FIG. 15A. As shown, as the additive particle size increases, both the B5 value and the Weibull scale value appear to decrease. Similar testing was conducted for a second set of examples having decorative layers with the composition described herein with respect to Example 23. The particle size for the 118 VTC additive was varied in the same manner (with d50 particle sizes of 1 μm, 2.5 μm, and 5 μm, respectively) as in the first set of examples depicted in FIGS. 13A-13C. ROR testing was conducted for the second set of examples and the B5 values and Weibull scales were plotted as a function of the particle size in FIG. 15B. As shown, the B5 values and Weibull scales of the second set of examples also tended to decrease with increasing additive particle size. Based on these results, it may be preferrable that the porosity-inducing additive component have a d50 particle size that is less than or equal to 10 μm (e.g., greater than or equal to 0.01 μm and less than or equal to 10 μm, or more preferably less than or equal to 5 μm) to avoid detrimental effects on mechanical performance. In embodiments, the porosity-inducing additive component may have a particle size that is greater than or equal to 0.01 μm and less than or equal to 10 μm (e.g., greater than or equal to 0.1 μm and less than or equal to 10 μm, greater than or equal to 0.5 μm and less than or equal to 10 μm, greater than or equal to 1.0 μm and less than or equal to 10 μm, greater than or equal to 0.01 μm and less than or equal to 5 μm, greater than or equal to 0.1 μm and less than or equal to 5 μm, greater than or equal to 0.5 μm and less than or equal to 5 μm, greater than or equal to 1.0 μm and less than or equal to 5 μm, greater than or equal to 0.01 μm and less than or equal to 2.5 μm, greater than or equal to 0.1 μm and less than or equal to 2.5 μm, greater than or equal to 0.5 μm and less than or equal to 2.5 μm, greater than or equal to 1.0 μm and less than or equal to 2.5 μm). In embodiments, the d50 particle size of the porosity-inducing component is greater than or equal to 1.0 μm and less than or equal to 5 μm. Maintaining the particle size in these ranges may beneficially prevent the decorative layers described herein from having a detrimental effect on mechanical performance of the glass articles described herein (e.g., the decorative layers may not degrade B5 or B10 values of the bare glass substrates by more than 10%).

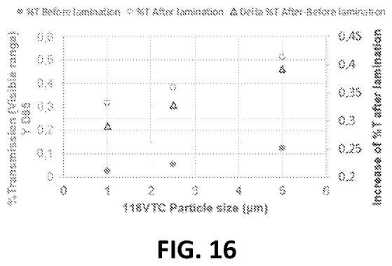

To assess the impact of the particle size of the porosity-inducing component on optical performance, integrated optical transmission was measured for the second set of examples both prior to and after lamination to another glass ply of aluminosilicate glass via a PVB interlayer. Light from a D65 illuminate was transmitted through the samples to measure optical transmission performance. The results are depicted in FIG. 16. As shown, both prior to and after lamination, the integrated optical transmission increases with increasing particle size for the porosity-inducing component. Particularly, after lamination, samples with d50 particle sizes less than 5 μm exhibited optical transmittances of less than 0.5%. Each of the samples also exhibited an increase in integrated optical transmittance from lamination. As shown in FIG. 16, the difference both prior to and after lamination is the smallest with the smallest particle size. Put differently, lamination made the smallest difference in terms of optical transmission when the particle size of the porosity-inducing component was smallest. This indicates that smaller particle sizes (e.g., d50 particle sizes of less than 5 μm, less than 3 μm, or less than 2 μm) may be beneficial from both a mechanical and optical performance perspective.

In embodiments, the porous decorative layers described herein may be characterized in that they include at least 15 vol % of a porosity-inducing component (e.g., a low CTE additive component, a pigment, or other filler such as alumina or zeolite). In embodiments, the porous decorative layers described herein may include an amount of porosity-inducing component particles (e.g., one or more of a low CTE additive component, a pigment additive, or any of the other suitable materials described herein) that constitutes from 15% to 40% by volume of the porous decorative layer. Such amounts may ensure adequate porosity to provide the desirable mechanical performance attributes described herein. The term “porous decorative layer” is used interchangeably herein with “porous inorganic layer.”

The present disclosure contemplates the production of porous decorative layers via a variety of different techniques. The porosity-inducing components described herein (e.g., low CTE additive components, alumina, pigment additives, or other suitable materials) are generally added to an enamel (uncured) in an amount that is sufficient to induce porosity after firing (e.g., for pigments, above a critical pigment volume concentration and a similar quantity for other porosity-inducing components). The amount of porosity-inducing component needed to induce porosity in the decorative layer may vary depending on the composition of the enamel (e.g., the composition of the glass frit component and/or the amount of pigments or other fillers already present in the enamel). In embodiments, rather than introducing a porosity-inducing component particles into an enamel, porosity may be created via introducing organic pore former materials which, after thermal degradation during firing, will generate porosity. The organic material may be burned off during firing, for example, and leave voids in the decorative layer in any of the amounts described herein. Examples formed using such a technique may not include porosity-inducing component particles in the cured decorative layer to the same extent as other examples that rely solely on porosity-inducing component particles to induce porosity. Any suitable method to form porosity in a frit-based decorative layer may be used.

As used herein, the term “dispose” comprises coating, depositing and/or forming a material onto a surface using any known method in the art. The disposed material may constitute a layer, as defined herein. The phrase “disposed on” comprises the instance of forming a material onto a surface such that the material is in direct contact with the surface and also comprises the instance where the material is formed on a surface, with one or more intervening material(s) between the disposed material and the surface. The intervening material(s) may constitute a layer, as defined herein.

Ranges can be expressed herein as from “about” one particular value, and/or to “about” another particular value. When such a range is expressed, another embodiment comprises from the one particular value and/or to the other particular value (i.e., the range is inclusive of the expressly stated endpoints). Similarly, when values are expressed as approximations, by use of the antecedent “about,” it will be understood that the particular value forms another embodiment. For example, the range “from about 1 to about 2” also expressly comprises the range “from 1 to 2”. Similarly, the range “about 1 to about 2” also expressly comprises the range of “1 to 2”. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, comprising: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” comprise plural referents unless the context clearly dictates otherwise. Thus, for example, reference to “a” component comprises aspects having two or more such components, unless the context clearly indicates otherwise.

Construction and arrangements of the compositions, assemblies, and structures, as shown in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. Materials, such as the glazing disclosed herein, may be used for glazing in architectural applications (e.g., windows, partitions) or may be otherwise used, such as in packaging (e.g., containers). The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present inventive technology.

1. A decorated glass article comprising:
a glass substrate comprising a first major surface and a second major surface disposed opposite to the first major surface; and
a decorative layer adhered to at least a portion of the second major surface, the decorative layer comprising:
a glass flux matrix; and
a plurality of pores, wherein:
the glass substrate comprises a thickness that is greater than or equal to 2.1 mm,
the decorative layer comprises a coefficient of thermal expansion (“CTE”) that is within 23×10⁻⁷ K⁻¹ of a CTE of the glass substrate, and
the decorated glass article exhibits a B5 value of greater than or equal to 45 MPa when at least ten of the decorated glass articles are subjected to ring-on-ring strength testing according to ASTM C-1499-03.

2. The decorated glass article of claim 0, wherein the porosity is greater than or equal to 5%.

3. The decorated glass article of claim 1, wherein the B5 value is greater than or equal to 55 MPa.

4. The decorated glass article of claim 1, wherein the decorative layer comprises at least 15% by volume of porosity-inducing component particles.

5. The decorated glass article of any of claim 4, wherein the porosity-inducing component particles comprises a plurality of particles of at least one of a β-eucryptite ceramic, alumina, a pigment additive, and zeolite.

6. The decorated glass article of any of claim 5, wherein the plurality of particles comprises a d50 particle size that is greater than or equal to 1 μm and less than or equal to 5 μm.

7. The decorated glass article of claim 1, wherein the decorative layer covers greater than or equal to 5% of a total surface area of the second major surface.

8. The decorated glass article of claim 1, wherein at least one of:
the glass substrate is not chemically strengthened, and
the glass substrate is formed of a soda lime silicate glass composition.

9. The decorated glass article of claim 1, wherein the decorative layer is encapsulated in a polymeric material.

10. The decorated glass article of claim 1, wherein a difference between the CTE of the decorative layer and the CTE of the glass substrate is greater than or equal to 15×10⁻⁷ K⁻¹.

11. The decorated glass article of claim 1, wherein the decorative layer comprises greater than or equal to 20 wt % and less than or equal to 40 wt % of low CTE additive component particles, wherein at least some of the low CTE additive component particles comprise a CTE that is less than or equal to 10×10⁻⁷ K⁻¹.

12. (canceled)

13. The decorated glass article of claim 1, wherein the decorative layer comprises greater than or equal to 5 wt % of a pigment additive.

14. The decorated glass article of claim 13, wherein the pigment additive comprises at least one of a CuCr-based pigment, a MgFe-based pigment, and a FeCrCoNi-based pigment.

15. (canceled)

16. The decorated glass article of claim 1, further comprising a second glass substrate and an interlayer disposed between the second glass substrate and the second major surface, wherein a polymeric material of the interlayer is present in the plurality of pores.

17. The decorated glass article of claim 16, wherein the glass article exhibits a L* value of less than or equal to 30 in areas where the decorative layer is disposed.

18. The decorated glass article of claim 17, wherein the glass article exhibits a L* value of less than or equal to 10 in areas where the polymeric material is present in the plurality of pores

19. The decorated glass article of claim 18, when light from a D65 illuminant is reflected from the glass substrate, the light exhibits a maximum ΔE value, computed using the CIE76 formula and between two different positions of the glass article where the decorative layer is disposed, that is less than or equal to 3.0.

20. A decorated glass article comprising:
a glass substrate comprising a coefficient of thermal expansion (“CTE”) that is less than or equal to 55×10⁻⁷ K⁻¹, a first major surface, and a second major surface disposed opposite to the first major surface; and
a decorative layer adhered to at least a portion of the second major surface, the decorative layer comprising:
a glass flux matrix,
a plurality of low CTE additive component particles, and
a plurality of pores, wherein:
the decorative layer comprises greater than 15 wt % of the low CTE additive component particles,
each of the plurality of low CTE additive component particles comprises a CTE that is less than or equal to 10×10⁻⁷ K⁻¹, and
the decorative layer comprises a CTE that is within 15×10⁻⁷ K⁻¹ of the CTE of the glass substrate.

21. The decorated glass article of claim 20, wherein the decorated glass article comprises a probability of breakage that is less than 10% when subjected to ring-on-ring testing at a load of 60 MPa with a ring diameter of 32 mm.

22. (canceled)

23. (canceled)

24. The decorated glass article of claim 20, wherein the decorative layer comprises greater than or equal to 20 wt % and less than or equal to 40 wt % of the low CTE additive component particles, wherein the decorative layer comprises greater than or equal to 5 wt % and less than or equal to 30 wt % of a pigment.

25. (canceled)

26. (canceled)

27. (canceled)

28. (canceled)

29. (canceled)

30. (canceled)
